(19) United States
(12) Patent Application Publication
(10) Pub. No.: US 2016/0012475 A1
(43) Pub. Date: Jan. 14, 2016

(54) METHODS, SYSTEMS, AND MEDIA FOR PRESENTING ADVERTISEMENTS RELATED TO DISPLAYED CONTENT UPON DETECTION OF USER ATTENTION

(71) Applicant: Google Inc., Mountain View, CA (US)

(72) Inventor: Eric HC Liu, Redwood City, CA (US)

(21) Appl. No.: 14/327,902

(22) Filed: Jul. 10, 2014

(51) Int. Cl. G06Q 30/02; G06F 3/01

(52) U.S. Cl. CPC G06Q 30/0251; G06F 3/013

(57) ABSTRACT

Methods, systems, and media for presenting advertisements related to displayed content upon detection of user attention are provided. In some implementations, a method for presenting information to a user is provided, the method comprising: detecting, using a hardware processor, presence of a user; causing content to be presented in response to detecting the presence of the user; detecting an eye-gaze direction of the user; detecting user attention to at least a portion of the content presented based on the eye-gaze direction of the user; and causing an advertisement related to the portion of the content to which user attention is detected to be presented by a device associated with the user.

### TECHNICAL FIELD

The disclosed subject matter relates to methods, systems, and media for presenting advertisements related to displayed content upon detection of user attention.

### BACKGROUND

Advertisements are typically shown based on time and/or location. For example, during broadcast television and radio programming, advertisements are often scheduled to display at designated commercial breaks or at designated times during the programming. In online advertising, advertisements are often presented in the web page when the web page is loaded. However, when advertisements are shown based on time and/or location, it can be difficult to determine whether a user is actually viewing an advertisement.

Accordingly, it is desirable to provide methods, systems, and media for presenting advertisements related to displayed content upon detection of user attention.

### SUMMARY

In accordance with various implementations of the disclosed subject matter, methods, systems, and media for presenting advertisements related to displayed content upon detection of user attention are provided.

In accordance with some implementations of the disclosed subject matter, a method for presenting information to a user is provided, the method comprising: detecting, using a hardware processor, presence of a user; causing content to be presented in response to detecting the presence of the user; detecting an eye-gaze direction of the user; detecting user attention to at least a portion of the content presented based on the eye-gaze direction of the user; and causing an advertisement related to the portion of the content to which user attention is detected to be presented by a device associated with the user.

In accordance with some implementations of the disclosed subject matter, a system for presenting information to a user is provided, the system comprising: a hardware processor that is programmed to: detect presence of a user; cause content to be presented in response to detecting the presence of the user; detect an eye-gaze direction of the user; detect user attention to at least a portion of the content presented based on the eye-gaze direction of the user; and cause an advertisement related to the portion of the content to which user attention is detected to be presented by a device associated with the user.

In accordance with some implementations of the disclosed subject matter, a non-transitory computer-readable medium containing computer executable instructions that, when executed by a processor, cause the processor to perform a method for presenting information to a user is provided, the method comprising: detecting presence of a user; causing content to be presented in response to detecting the presence of the user; detecting an eye-gaze direction of the user; detecting user attention to at least a portion of the content presented based on the eye-gaze direction of the user; and causing an advertisement related to the portion of the content to which user attention is detected to be presented by a device associated with the user.

In accordance with some implementations of the disclosed subject matter, a system for presenting information to a user is provided, the system comprising: means for detecting presence of a user; means for causing content to be presented in response to detecting the presence of the user; means for detecting an eye-gaze direction of the user; means for detecting user attention to at least a portion of the content presented based on the eye-gaze direction of the user; and means for causing an advertisement related to the portion of the content to which user attention is detected to be presented by a device associated with the user.

In some implementations, the system further comprises: means for causing metadata associated with the portion of the content to which user attention is detected to be associated with the user; and means for causing additional content to be presented to the user based at least in part on the metadata that has been associated with the user.

In some implementations, the system further comprises: means for detecting that a mobile device associated with the user is connected to a local area network; and means for causing the advertisement to be presented by the mobile device.

In some implementations, the system further comprises: means for identifying the user; and means for determining that the user is associated with the mobile device based on the identification.

In some implementations, the means for identifying the user further comprises means for receiving image data of a person's face and means for comparing the image data with a known image of the user to determine the identity of the user.

In some implementations, the system further comprises: means for detecting the presence of a plurality of mobile devices including the mobile device associated with the user; means for identifying a plurality of users; means for determining that a subset of the plurality of users are each associated with one of the plurality of mobile devices; means for detecting an eye-gaze direction of each of the subset of the plurality of users; means for detecting user attention of a first user of the subset of the plurality of users to at least a portion of the content presented to the plurality of users based on the eye-gaze direction of the first user; and means for causing an advertisement related to the portion of the content to which user attention of the first user is detected to be presented by a first mobile device associated with the first user.

In some implementations, the system further comprises: means for requesting content based on the identification of the subset of the plurality of users; means for receiving content to be presented in response to the request; and wherein the means for causing content to be presented comprises means for causing the received content to be presented.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative example of a process for displaying information related to displayed content upon detection of user attention in accordance with some implementations of the disclosed subject matter.

FIG. 2 shows an illustrative example of a process for detecting a presence of a user in accordance with some implementations of the disclosed subject matter.

FIG. 3 shows an illustrative example of a process for detecting an action indicative of user attention in accordance with some implementations of the disclosed subject matter.

FIGS. 4A-4F show diagrams illustrating an example of a process for displaying information related to displayed content upon detection of user attention in accordance with some implementations of the disclosed subject matter.

FIG. 5 shows a schematic diagram of an illustrative system suitable for implementation of an application for displaying information related to displayed content upon detection of user attention in accordance with some implementations of the disclosed subject matter.

FIG. 6 shows a detailed example of the server and one of the content display devices of FIG. 5 that can be used in accordance with some implementations of the disclosed subject matter.

FIG. 7 shows a diagram illustrating an example of a data flow used in processes of FIGS. 1-3 in accordance with some implementations of the disclosed subject matter.

FIG. 8 shows another diagram illustrating an example of a data flow used in processes of FIGS. 1-3 in accordance with some implementations of the disclosed subject matter.

FIG. 9 shows an illustrative example of a process for presenting an advertisement related to displayed content upon detection of user attention to a portion of the content in accordance with some implementations of the disclosed subject matter.

FIG. 10 shows an illustrative example of a process for determining which content presented to a user is interesting to the user in accordance with some implementations of the disclosed subject matter.

FIG. 11 shows an illustrative example of a process for presenting content based on which content caused user attention in accordance with some implementations of the disclosed subject matter.

FIG. 12 shows a diagram illustrating an example of a data flow used in processes of FIGS. 9-11 in accordance with some implementations of the disclosed subject matter.

### DETAILED DESCRIPTION

In accordance with various implementations, mechanisms (which include methods, systems, and media) for displaying information related to displayed content upon detecting user attention are provided. Generally speaking, information related to content can be presented when a user performs a user action indicative of attention to the content. For example, the mechanisms can present content to a user that is otherwise occupied and, upon detecting that the user has looked at the content, the mechanisms can display information related to the content currently being displayed. In a more particular example, a user may be reading a book while sitting in front of a television that is displaying content presented by the mechanisms (e.g., a slideshow of images, etc.). A particular item of content catches the user's eye (e.g., a particular image grabs the user's attention) and the user looks at the television screen as the particular item is being displayed. In response to this detection, the mechanisms can present additional information related to the particular item of content to the user.

It should be noted that, prior to detecting one or more user actions indicative of attention to the content, these mechanisms provide the user with an opportunity to provide a consent or authorization to perform such detections. For example, upon loading an application on a computing device, such as a television device, the application can prompt the user to provide authorization for performing such detections, transmitting information relating to the detections, and/or presenting additional information relating to a content item of interest. In a more particular example, in response to downloading the application and loading the application on the computing device, the user can be prompted with a message that requests (or requires) that the user provide consent prior to performing these detections. Additionally or alternatively, in response to installing the application, the user can be prompted with a permission message that requests (or requires) that the user provide content prior to performing these detections and/or transmitting information relating to these detections. In the instance where the user consents to the use of such data, information relating to the detections can be used for displaying information related to the displayed content.

In some implementations, the mechanisms can automatically present the content to a user when the application detects the presence of a user. For example, if a user enters a living room environment that has a media device that is executing the mechanisms and the mechanisms detect the user's presence, the mechanisms can begin presenting content for the user. As another example, if the mechanisms are set on a timer, the mechanisms can present content based on a time of day, a day of the week, etc. As yet another example, if a user has chosen to associate a mobile device (e.g., a smartphone, a mobile phone, a tablet computer, etc.) with a media device executing the mechanisms, the mechanisms can detect the presence of the mobile device on a network that is connected to the media device executing the mechanisms, and the mechanisms can begin presenting content.

In some implementations, the content to be presented can include one or more content items. The content items can include images, videos, advertisements, audio, user-generated content, text, etc. For example, the content items can include a collection of images that can be presented to the user as a slideshow (e.g., multiple image files stored in a media device and/or database). As another example, the content items can include a collection of video clips that can be presented to the user as a slideshow of video clips. As yet another example, the content items can include multimedia advertisements (e.g., images, text, video, etc.). By way of example, the content items are often discussed herein as a slideshow of images. It should be noted that, although the implementations and examples generally describe a slideshow of images, the content items can contain various different types of content. For example, the content can include stored content on a digital video recorder (DVR).

In some implementations, the content items can include a combination of different types of content items. For example, the content items can include images, videos and advertisements. As another example, audio clips such as songs (or portions of songs) can be included in the content. In such an example, a song can be played while other content items are being presented to the user.

In some implementations, a single content item can be presented to the user at a time. For example, in a slideshow of images, a single still image can be presented to the user for a predetermined period of time, and after the predetermined period of time has elapsed a next image can be presented to the user.

In some implementations, multiple content items can be presented to the user at the same time. For example, multiple items can be displayed on a display in a non-overlapping fashion and the items can be displayed for a period of time before being replaced. In such an example, the time at which the content items are replaced can be staggered such that the content items are displayed overlapping in time. In another example, multiple content items can be displayed in a partially or fully overlapping fashion. In such an example, the position where the content items are displayed within the screen can be changed in time and the content items can move together or independently.

In some implementations, where multiple content items are simultaneously displayed, different types of content items (e.g., images, videos, advertisements, etc.) can be displayed together. For example, images and videos can be displayed simultaneously in a partially overlapping or a non-overlapping fashion.

In some implementations, the content items being presented to the user can act as a background application that is not intended to be the focus of the user's attention for a sustained period of time. For example, a media device that is playing music can also display content items in accordance with the mechanisms described herein in cases where the media device is coupled to a display. As another example, if a user is reading a book in her living room, the mechanisms described herein can be used to display content as a background activity. As yet another example, the mechanisms described herein can be used to display images that can help set an ambiance desired by the user if the user is having a party. As yet another example, the mechanisms described herein can be used to provide dynamic decoration to a public or private space, such as an airport terminal, a restaurant, a user's living room, etc.

In some implementations, content metadata can be associated with the content items. The content metadata can contain information that describes the content item. This can include information about the type of information contained in the content file (e.g., an image, a video, a file type, etc.), information about the subject of the content item (e.g., a description of what is depicted in an image), a location where the content item was recorded (in the case of an image, a video, etc.), a source where the content item originates (for example, a blog post, a web page, etc.), etc. In some implementations, the metadata can also include indices that are used to classify the content item.

In some implementations, a user can choose to enable the content items to be displayed based on the identity of the user that is present. For example, the user can set content consumption preferences for what type of content the user enjoys. More particularly, one or more categories can be presented to the user for selection. Additionally, each of the categories can include sub-categories for selection by the user. For example, categories, such as landscapes, animals, sports, art, etc. can be presented to the user for selection. The landscape category can include sub-categories such as beaches, mountains, lakes, etc.

In some implementations, the preferences of a user can be discovered based on observed user interest. For example, if it is determined that the user often pays attention when images of panda bears are shown, more images of panda bears and other animals similar to panda bears can be selected as content items for presentation to the user.

In some implementations, when it is determined that a user looks at a content item being displayed (or otherwise shows attention to the content item), the mechanisms can cause information related to the content item to be displayed to the user. For example, the related information can be an advertisement that is chosen at least partially based on the contents of the content item. More particularly, content metadata that is associated with the content item can be used in retrieving an advertisement to be presented as the related information. As another example, an article or web page related to the content item can be presented to the user. As yet another example, facts about what is depicted in the content item can be displayed as the related information.

In some implementations, a particular user's attention can trigger the display of related information, while attention by other users can be ignored or otherwise disregarded. For example, a particular user can set up a profile associated with the mechanisms. In such an example, when content is being displayed the attention of the particular user associated with the profile can trigger the display of related information, while attention of a user that is not associated with a profile can be disregarded or ignored.

In some implementations, upon presenting related information to a user, the mechanisms can receive a request for supplemental information. For example, if a snippet of an article that accompanied an image is presented as related information when the image is presented as content, the user can request that a copy of the article be accessed so that the user can read the article. In such an example, the article can be presented using the display being used to present the content items. Additionally or alternatively, the article can be accessed on a second device (e.g., a smartphone, a tablet computer, a laptop computer, a personal computer, etc.) that is not being used to present the content.

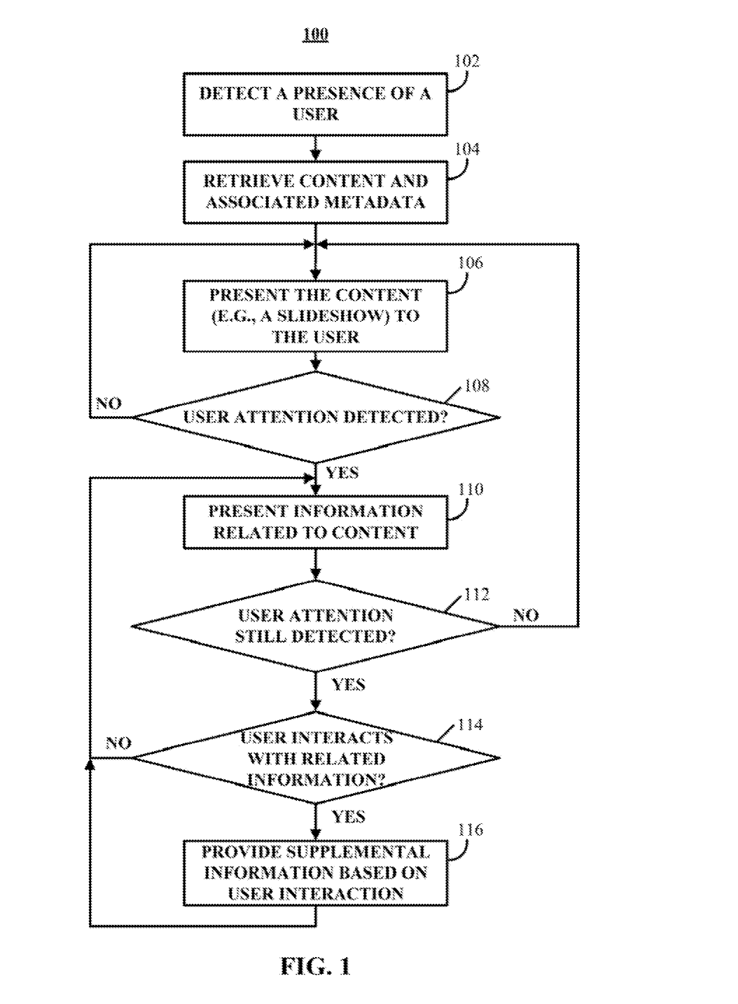

Turning to FIG. 1, a content display application can begin by detecting a presence of a user at 102. The presence of a user can be detected using any suitable techniques. For example, in some implementations, the content display application can determine whether a user is present in the vicinity of a display (e.g., near the display, in front of the display, in the same room as the display, etc.). Additionally or alternatively, the content display application can determine whether a user is present in an area such as a floor of a building in which a display is located. Additionally or alternatively, the content display application can determine the presence of a user based on a current time and day. For example, the content display application can assume a user is present during certain times of the day (e.g., from 9 A.M. to 5 P.M.). In some implementations, any suitable combination of techniques can be used to determine the presence of a user.

It should be noted that, prior to detecting the presence of a user or any other suitable detections described herein, the content display application can provide the user with an opportunity to provide a consent or authorization to perform such detections. For example, upon loading the content display application on a computing device, such as a television device, the application can prompt the user to provide authorization for performing such detections, transmitting information relating to the detections, and/or presenting additional information relating to a content item of interest. In a more particular example, in response to downloading the content display application from a suitable marketplace and loading the content display application, the user can be prompted with a message that requests (or requires) that the user provide consent prior to performing a detection of user presence. Additionally or alternatively, in response to installing the content display application, the user can be prompted with a permission message that requests (or requires) that the user provide content prior to performing these detections and/or transmitting information relating to these detections. In the instance where the user consents to the use of such data, user presence at 102 can be detected.

In some implementations, the presence of a user can be detected using a camera or other suitable imaging device that periodically captures images and detects the presence or absence of a user in the images. For example, the camera can capture images every second (or every five seconds, ten seconds, or any other suitable interval of time) and the content display application can determine whether a user is present in the image using any suitable image processing technique. More particularly, the content display application can detect differences between consecutive images to determine a user's presence, where differences above a threshold amount can indicate the presence of a user.

In another example, if the camera or other suitable imaging device is configured to measure distance as well as images (e.g., through use of projected light, through use of stereoscopic imaging, through use of detecting a focusing state of the camera sharpness of a subject, etc.), an estimated size of a subject can be determined based on a distance to the subject and the subjects relative size in an image. The estimated size can be compared to a size of a user and if the sizes match the content display application can determine that the user is present.

In yet another example, the content display application can detect whether a face is present in the application using facial recognition techniques that determine the presence of a human face in an image. In still another example, if the content display application detects a face, the content display application can use a facial recognition process to determine whether the face is a particular user's face. It should be noted that in such an example, the mechanisms can detect the presence or absence of a face and not record the identity of the face or the activities of the user.

In still another example, the content display application can perform image processing on the image captured by the camera to determine if a human is present in the image by recognizing various characteristics of a human figure such as a head, one or more arms, a torso, etc. In some implementations, any of the techniques described herein can be used to determine whether a user is present using a camera. In some implementations, any suitable technique can be used to determine whether a user is present using a camera.

In some implementations, a motion detector can be used to determine if a user is present. For example, the content display application can receive a signal that indicates whether motion has been detected. If motion has been detected, the content display application can make a determination that a user is present.

In some implementations, detection of a connection between a device (e.g., a set-top box, a digital media receiver, a smart television, a game console, etc.) executing the content display application and a device associated with a user can indicate that a user is present. Such a connection can be an ad-hoc wireless connection, a common connection to a local area network (LAN) and/or a wireless LAN, a Bluetooth connection, a near-field communication connection, a Universal Serial Bus (USB) connection, a wireless USB connection, a connection using light waves, etc.

For example, a device executing the content display application can be connected to a LAN and can detect when a second screen device (e.g., a smartphone, a tablet computer, a laptop computer, etc.) associated with a user establishes a connection with the LAN. In such an example, the content display application can determine that the user is present when the second screen device associated with the user establishes a connection with the LAN.

In another example, a device executing the content display application can be configured to connect to a device associated with a user using a Bluetooth communication standard when the device associated with the user is within a Bluetooth connection range. In such an example, the content display application can determine that the user is present when the device executing the content display application establishes a connection with the device associated with the user.

In some implementations, detection of a user launching an application can be used to indicate that a user is present. For example, a user can issue an instruction to a device that executing the content display application that instructs a processor to launch the content display application. More particularly, the user can use an input device, such as a keyboard, remote control, touchscreen, etc. to instruct the processor to launch the content display application.

In some implementations, an identity of the user can be determined at 102 and the identity of the user can be used to retrieve content customized for the identified user. As described below, such identity information can be used to determine content to be displayed based on preferences and/or characteristics of the identified user. In one example, facial recognition techniques can be used to determine an identity of a particular user whose presence has been detected. In another example, a size and shape of a user can be used to determine an identity of a particular user whose presence has been detected. In yet another example, an identification (such as an Internet Protocol (“IP”) address, a Media Access Control (“MAC”) address, etc.) of a user device present on a network can be used to determine an identity of a particular user whose presence has been detected, for example, by the presence of the user device on the network. In still another example, credentials (e.g., a username, a password, etc.) entered by a user by logging in to a media device executing the content display application can be used to identify a user.

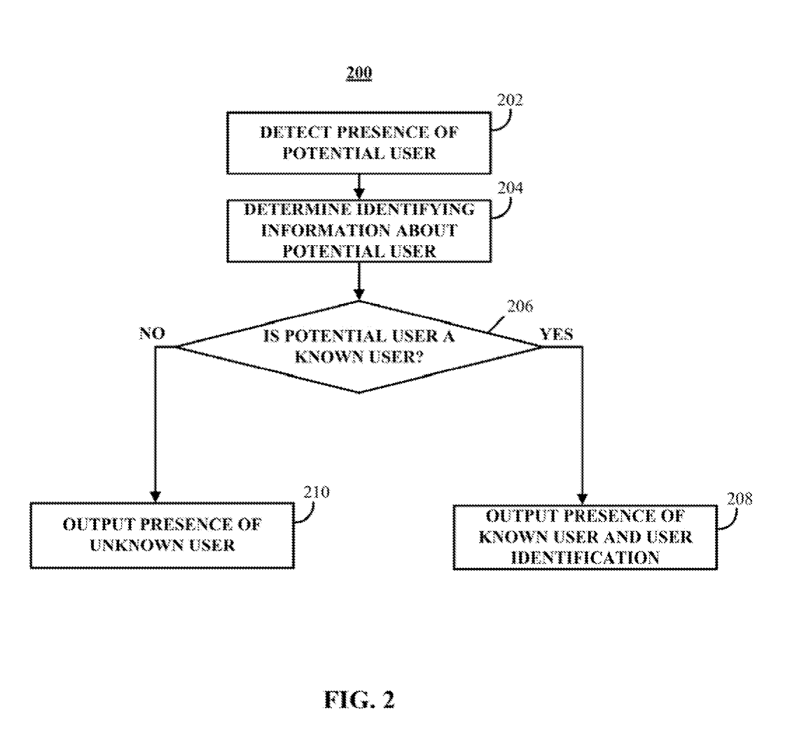

FIG. 2 shows an example 200 of a process for detecting the presence of a user in accordance with some implementations. At 202, the presence of a potential user can be detected using any suitable technique. For example, an image from a camera can be analyzed to detect the presence of a potential user. As another example, a motion detector can be used to detect the presence of a potential user. As yet another example, a presence of a user device can be detected if a communication is received that indicates the presence of the user device.

At 204, identifying information about the potential user can be determined. In some implementations, identifying information can be identifying information associated with the potential user. For example, facial features of the potential user can be determined for performing facial recognition. As another example, a size and/or shape of the potential user can be determined. In some implementations, identifying information can be determined by determining identifying information, such as an identification number. For example, a user device identification number associated with a user device can be determined.

At 206, it can be determined whether the identity of the potential user corresponds to a known user. In some implementations, a list (or database) of known users and associated identity information of the known users can be stored. The identity of the potential user can be compared to the list (or database) to determine if the potential user is a known user. For example, facial features of the potential user can be compared to facial features of a known user. As another example, the user device identification number associated with the potential user can be compared to user device identification numbers of known user devices.

If the potential user is determined to be a known user (“YES” at 206), the presence of a known user and user identification information identifying the known user can be output at 208. Otherwise, if the potential user is determined to be an unknown user (“NO” at 206), the presence of the unknown user can be output at 210.

In some implementations, the content display application can execute process 200 to determine the presence of a user and whether the user is a known user or an unknown user. Alternatively, the content display application can receive an input from another application and/or another device indicating the presence of a user and whether the user is a known or unknown user. For example, a camera coupled to a device executing the content display application can include a processor and a list of known users, and the camera can output a signal to the device executing the content display application that indicates the presence of a user and whether the user is a known user or an unknown user.

In some implementations, the information indicating that the user is a known user or an unknown user can be used in determining what content to display and whether a user has performed an action indicative of user attention, as described below herein. For example, as described below in connection with 104, which content is retrieved to be presented to the user can be based on an identity of the user whose presence is detected. As another example, as described below in connection with 108, detection of user attention can be based on whether a user is known or unknown. In such an example, detection of attention for an unknown user can be ignored or the content display application can inhibit detection of attention for an unknown user. As yet another example, detection of user attention can be based on detecting a combination of actions by a user, such as detecting that a face angle of the user indicates user attention and concurrently detecting a voice command of the user. In such an example, a user can be provided with an opportunity to choose actions to be used by the content display application to detect user attention from, for example, a list of actions that may indicate user attention.

Returning to FIG. 1, the content display application can retrieve content and associated content metadata at 104. In some implementations, the content can be retrieved from memory of a device executing the content display application. For example, the content display application can retrieve content from non-volatile memory (e.g., a hard drive, a solid state drive, a flash memory, an optical disk, etc.) of the device executing the content display application (e.g., a set-top box, a digital media receiver, a laptop computer, etc.). As another example, the content display application can retrieve content from volatile memory (e.g., random access memory (“RAM”), etc.). In such implementations, a processor of the device executing the content display application can cause the content and associated content metadata to be retrieved from memory.

Additionally or alternatively, the content can be retrieved from a media device connected to a local area network to which the device executing the application is connected. For example, the device executing the application can request content and associated content metadata from a non-volatile memory of a media device connected to the same local area network. More particularly, the device executing the content display application can request content and content metadata from a second device (e.g., a set-top box, a digital media receiver, a laptop computer, a personal computer, etc.) connected to the same local area network. In response to receiving a request for content and content metadata, a processor of the second device can retrieve the content and content metadata from memory or any other suitable storage and cause the content and content metadata to be transmitted (for example, over the network to which the device executing the content display application and the second device are connected, e.g., a LAN) to the device executing the content display application. In such implementations, a processor of the device executing the content display application can receive the content and content metadata transmitted by the second device.

Additionally or alternatively, the content can be retrieved from a remote device (e.g., a server, etc.) connected to the device executing the content display application by a network (e.g., the Internet, etc.) or a combination of networks (e.g., a LAN and the Internet, etc.). For example, the device executing the application can request content and associated content metadata from a server through a network (e.g., the Internet). In response to receiving the request for content and content metadata, the server can cause the requested content and content metadata to be transmitted to the device executing the application. In such implementations, a processor of the device executing the content display application can receive the content and content metadata transmitted by the remote device.

In some implementations, a processor of the device executing the content display application can request content and associated content metadata from a server in response to detection of a presence of a user at 102. For example, updated content (having associated content metadata) to be presented by the content display application can be requested from a server in response to detection of a user's presence. This can allow for new and/or updated content to be displayed to a user each time a user's presence is detected. In such implementations, a processor of the device executing the content display application can receive the content and content metadata transmitted by the server.

In some implementations, a processor of the device executing the content display application can request content and associated content metadata from a server periodically. For example, the processor can request content and associated content metadata from the server and store content and associated content metadata received in response to the request. In response to a user's presence being detected at 102, the processor can retrieve content and determine when the content was received. If a predetermined period of time has passed since the content was received (e.g., 24 hours, one week, etc.), the processor can request new and/or updated content from the server.

At 106, the content display application can cause the content to be presented on a display device. In some implementations, the content can be a slideshow of images. In one example, each of the images in the slideshow can be presented to the user one at a time for a predetermined period of time (e.g., fifteen seconds, thirty seconds, etc.). In such implementations, the slideshow can include images from one source or multiple sources (e.g., a locally stored database of images, images stored on a media device connected to a LAN, a server, etc.). Furthermore, the images to be displayed can be selected using any suitable technique as described herein. For example, the images can be popular images related to one or more topics of interest to the user. In some implementations, the content can include videos that are played back to the user.

At 108, the content display application can detect whether a user has performed an action indicative of user attention. In some implementations, the content display application can receive a signal regarding an angle of a user's face with respect to a display utilized for presentation of the content. In such implementations, the content display application can determine that user attention is detected when the angle between the user's face and the display is less than a threshold angle (e.g., when the angle is less than 15 degrees, 20 degrees, etc.).

In one particular example, if a user is using a second screen device (e.g., a laptop computer) in front of a display while the content display application causes a slideshow of images to be displayed on the display, it may be likely that the angle between the user's face and the display is greater than the threshold angle. As long as this is the case, the content display application does not detect user attention. However, if an image that is displayed catches the user's attention, the user can look up to, for example, see the image more clearly. In response, the content display application can detect that the user has performed an action indicative of user attention when the user looks up from reading to see the image being displayed.

Additionally or alternatively, the angle of the user's face with respect to the display can be determined by the content display application from an image (or images) received from a camera (or cameras) coupled to the device executing the content display application, and the result can be used in determining whether a user has performed an action indicative of user attention.

In some implementations, the content display application can receive a signal regarding an eye-gaze direction of a user's eye(s) with respect to a display utilized for presentation of the content. In such implementations, the content display application can determine that user attention is detected when an angle between the user's eye-gaze direction and the display is less than a threshold angle (e.g., when the angle is less than 15 degrees, 20 degrees, etc.). Additionally or alternatively, the direction of the user's eye-gaze with respect to the display can be determined by the content display application from an image (or images) received from a camera (or cameras) coupled to the device executing the content display application, and the result can be used in determining whether a user has performed an action indicative of user attention.

In some implementations, the content display application can receive a signal regarding a position of a user's hand and/or arm with respect to the user and/or with respect to a display utilized for presentation of the content. In such implementations, a change in position of the user's hand and/or arm from a first position to a raised position can indicate user attention. For example, if the content display application determines that the user is pointing at the display this can be an action that indicates user attention. As another example, if the content display application determines that the user's hand moved from a position close to the user's body to an outstretched position this can be an action that indicates user attention. As yet another example, if the content display application determines that the user's hand is waving this can be an action that indicates user attention.

In some implementations, the content display application can receive a signal regarding an action taken by the user with respect to a user device used for interacting with the content display application and/or the display used for presenting content to the user. For example, if a remote control is configured to detect motion (e.g., through the use of accelerometers, gyroscopes, etc.) and is associated with a media device executing the content display application and/or a display used for presenting content to the user, the content display application can receive a signal indicating that motion of the remote control has been detected. This can be interpreted as an indication of user attention by the content display application.

As another example, if a second screen device (e.g., a smartphone, a tablet computer, a laptop computer, etc.) associated with the user is connected to a device executing the content display device (directly, through a local area network, etc.), a user action at the second screen device and/or movement of the second screen device (if the second screen device is configured to detect motion) can be communicated to the content display application. The content display application can use the communication to determine whether the user action and/or movement is indicative of user attention. More particularly, unlocking a second screen device from a locked mode, waking a second screen device from a sleep mode, picking up a second screen device, opening a web browser on a second screen device, etc. are examples of user actions that can be interpreted as user attention.

In some implementations, the content display application can receive a signal regarding a sound detected by a microphone (or microphones) coupled to a device executing the content display application. For example, if the content display application detects that a user said something about the content presented to the user, the content display application can interpret this as an action indicative of user attention. In such an example, if the content display application determines that the user said a word that matches a word (or a synonym of a word) in the associated content metadata, the content display application can determine that the user is paying attention to the displayed content. As another example, if the content display application determines that the user has made any recognized vocalization, the content display application can interpret this as an action indicating user attention.

In some implementations, the content display application can be responsive to any user paying attention to the content displayed by the content display application. For example, if a user's face angle is used to detect user attention, any face recognized in an area in front of a screen that has an angle to the display less than a threshold can indicate user attention. More particularly, in such implementations, the content display application does not distinguish one face from another and therefore any person that is determined to be paying attention can trigger the display of related information.

In some implementations, the content display application can be sensitive to the actions of a particular user (or particular users) and disregard other users. For example, the content display application can recognize a known user(s) (e.g., a user that has created and/or associated a profile in connection with the content display application) using any suitable techniques (e.g., facial recognition, size recognition, voice recognition, device identification, etc.) and can detect user actions indicative of user attention from the known user(s). This can allow the content display application to ignore unknown users (e.g., users that do not have a profile) and only respond to known users.

If the content display application detects a user action indicative of user attention (“YES” at 108), the content display application can move to 110. Otherwise, if it is determined that user attention has not been detected (“NO” at 108), the content display application can return to 106 and continue to cause the content to be presented.

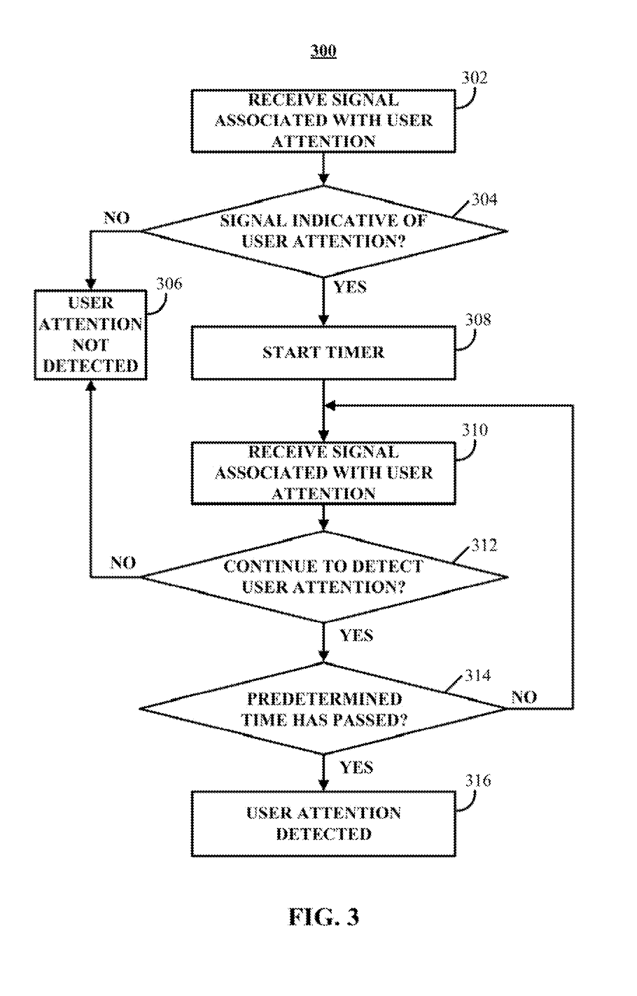

FIG. 3 shows an example 300 of a process for detecting user attention in accordance with some implementations. At 302, the content display application can receive a signal associated with user attention. Any suitable signal associated with user attention can be received at 302, including the signals described above. For example, in some implementations, the signal can be related to an angle of the user's face with respect to a display. Additionally or alternatively, a position of a user's hand can be determined and a signal indicating the position of the user's hand can be received at 302.

At 304, the content display application can determine if user attention is indicated by the signal. In some implementations, the content display application can determine if an angle of a user's face with respect to a display is less than a threshold angle (e.g., 10 degrees, 20 degrees, etc.). For example, the content display application can use image analysis techniques to determine from an image of the user whether the user is likely to be paying attention to the content presented at 106 based on the angle of the user's face.

In some implementations, the signal received at 302 can include information on the angle of the user's face with respect to a display, and the content display application can determine if the angle indicates that the user is paying attention to the content presented at 106.

If user attention is not indicated by the signal (“NO” at 304), the content display application can move to 306 and indicate that user attention is not detected. Alternatively, if user attention is indicated by the signal (“YES” at 304), the content display application can start a timer at 308.

In some implementations, the timer started at 308 can be a counter that indicates a number of frames where user attention is indicated. Additionally or alternatively, the timer can be a counter that counts a time (e.g., number of nanosecond, microseconds, milliseconds, etc.) that has elapsed from the time when the timer is started at 308.

At 310, the content display application can receive a signal associated with user attention. In some implementations, the signal received at 310 can be similar to the signal received at 302. Additionally or alternatively, the signal received at 310 can indicate a difference between a current state of user attention and a previous state of user attention.

At 312, the content display application can determine if user attention is still detected based on the signal received at 310. In some implementations, a determination at 312 of whether user attention is indicated by the signal received at 310 can be similar to the determination at 304 of whether user attention is indicated by the signal received at 302. For example, whether the angle of the user's face with respect to the display is less than a threshold angle can be determined.

If user attention continues to not be indicated (“NO” at 312), the content display application can move to 306 and indicate that user attention is not detected. Otherwise, if user attention is still indicated (“YES” at 312), the content display application can move to 314.

At 314, the content display application can determine if a predetermined amount of time has passed since the timer was started at 308. In some implementations, if the timer is a counter that counts a number of frames, the predetermined time can be a threshold number of frames (e.g., fifteen frames, thirty frames, etc.). Alternatively, if the timer that counts the time that has elapsed since the timer was started, the predetermined time can be a threshold amount of time (e.g., 500 milliseconds, one second, etc.).

If the predetermined amount of time has not passed (“NO” at 314), the content display application can return to 310. Otherwise, if the predetermined amount of time has passed (“YES” at 314), the content display application can move to 316 where a determination can be made that user attention is detected.

In some implementations, if the timer started at 308 is a counter that counts a number of frames where user attention has been detected, the counter can be incremented a specified number of frames (e.g., one frame, two frames, etc.) each time a signal associated with a new frame is received and based on the number of frames captured by a camera since the last signal was received.

In some implementations, in a time between when the timer is started at 308 and when the content display application either determines that user attention is not detected at 306 or that user attention is detected at 316, presentation of content can be paused. This can allow for the content being presented to remain unchanged while user attention is being determined.

In some implementations, if user attention is indicated at 304, the actions of 308-314 can be omitted and process 300 can be conclude by determining that user attention is detected at 316. For example, if the content display application is configured to detect user attention if user attention is indicated in a single frame, the actions of 308-314 can be omitted.

Referring back to FIG. 1, the content display application can, at 110, present information related to the content presented at 106 when user attention is detected at 108. In some implementations, the content display application can display information related to the content that was being presented to the user at the time that user attention was detected. Additionally, when a user action that indicates user attention is detected, the content display application can pause the presentation of content such that new and/or updated content is not presented to the user. Alternatively, if new content is displayed periodically (e.g., every 15 seconds, every minute, etc.), the content display application can start the period over when user attention is first detected corresponding to a particular item of content being presented to the user.

Additionally or alternatively, if there is more than one item of content being presented to the user at the time that user attention is detected, the content display application can make a judgment as to which item of content the user is most likely paying attention to. In one implementation, the content display application can receive a signal indicative of an eye-gaze direction of the user. This information can be used with information about a location of the user with respect to the display and the content currently being displayed to determine which item of content the user is most likely the item that the user is paying attention to. In another implementation, an item located closest to the center of the display at the time user attention is detected can be used to determine which item is most likely the item that interested the user. In yet another implementation, if the content items are displayed at different sizes, the content display application can determine that a largest item is most likely the item that caught the user's interest.

In some implementations, the information to be displayed at 110 can be automatically generated based on the content metadata associated with the content. In one implementation, the content metadata can be used to determine popular results associated with the content metadata. For example, if the content presented to the display at the time user attention is detected is an image with associated content metadata, the content display application can retrieve information to be presented at 110 based on the content metadata. In such an example, one or more keywords or phrases from the content metadata can be used to determine the most popular information related to the content metadata. In a more particular example, if the content is an image of Mount Fuji and the metadata includes the phrase “Mount Fuji,” the content display application can retrieve popular web pages and/or news articles related to Mount Fuji. Additionally or alternatively, the content display application can retrieve one or more facts about the subject of the image.

In some implementations, if the content metadata contains geographic coordinates where an image was taken the content display application can retrieve information about the location as related information to be presented at 110. For example, weather information can be retrieved, map information can be retrieved, a name of a city, town, park, etc. depicted in the image can be retrieved, etc.

In some implementations, if the content metadata contains geographic coordinates and direction information (e.g., a compass heading), the content display application can retrieve the names of landmarks located within the content item based on the location where the content item was captured and the direction.

In some implementations, an advertisement related to the content can be retrieved by the content display application based on the content metadata. For example, if a location is included in the content metadata (e.g., a name of a location, geographic coordinates, etc.) the content display application can determine the location and retrieve an advertisement related to travel to the location (e.g., an airline advertisement, hotel rates, etc.) as the related information. As another example, if the content metadata indicates that the content is related to a particular topic (e.g., sports, a celebrity, etc.) the content display application can retrieve an advertisement related to the topic or an advertisement targeted at user's interested in the topic (e.g., an advertisement targeted at sports enthusiasts can be shown, an advertisement targeted at user's interested in celebrities, etc.).

In some implementations, one or more data points about the user can be used to determine information to be presented at 110. For example, if the user has a profile and the profile indicates that the user is a child, information that has been determined to be appropriate for a child can be retrieved to be presented at 110. As another example, if a user has indicated that she does not want to be shown advertisements, the content display application can inhibit advertisements from being retrieved to be presented at 110.

In some implementations, information retrieved for presentation at 110 can be based on one or more interests of a user. These interests can be selected by the user and/or selected automatically by the content display application. For example, the user can select certain interests, such as, travel, sports, cooking, fashion, etc., and these interests can be used in retrieving the information for presentation at 110 and/or retrieving content at 104.

As another example, a user can choose to allow the content display application to retrieve content at 104 and/or retrieve information for presentation at 110 based on learned interests of the user. More particularly, the user can set a privacy level that indicates a level of personalized content to display, where a higher privacy level can allow for less personalization and therefore less personalized related information. If a user chooses to allow the content display application to learn interests, the content display application can note the types of content that the user pays attention to and use this information to infer the interests of the user.

It should be noted that in implementations described herein in which the content display application (or other mechanisms described herein) collects information about a particular user, the user can be provided with an opportunity to control whether the content display application (or other mechanisms) collects information about particular users and/or how collected user information is used by the content display application (or other mechanisms). Examples of information about a user can include the user's interests and identifying information of the user (e.g., information on a user's face, a user profile, user credentials, device identification, etc.). Additionally, certain information about the user can be stored locally (e.g., not shared), encrypted, and/or treated in one or more ways before it is stored to remove personally identifiable information. For example, after capturing an image of a particular user for facial recognition, information that can be used to identify the user can be extracted and the image can be deleted. As another example, the content display application can store user preferences and/or user interests for a particular user with an anonymous user identifier (e.g., a user identifier that is not associated with the user's name, the user's username and/or password, the user's email address, etc.). Using these techniques, the user can have control over what information is collected about the user and/or how that information is used by the content display application (or other mechanisms).

In some implementations, the information retrieved at 110 can include images that have been determined to be similar to the image that attracted the user's interest. For example, if the user showed interest in an image of a mountain, the content display application can show the user images and/or videos of mountains that have been determined to be similar to the image of a mountain that interested the user. As another example, if the user shows interest in an image with a particular person in it (e.g., a particular celebrity), more images of that person can be retrieved to be presented at 110.

At 112, the content display application can determine whether user attention continues to be detected. In some implementations, the same or similar techniques as described above can be used to determine user attention (e.g., face angle, eye-gaze direction, etc.) to determine if the user continues to pay attention.

If the content display application detects that user attention continues to be detected (“YES” at 112), the content display application can move to 114. Otherwise, if it is determined that user attention is not still detected (“NO” at 112), the content display application can return to 106 and continue to cause the content to be presented at 106.

At 114, the content display application can determine if the user has interacted with the related information presented at 110. In some implementations, the content display application can receive a signal indicating that the user requested supplemental information verbally. For example, a microphone coupled to the device executing the content display application can record a user interacting with the related information by requesting more information. In a more particular example, the content display application can use the microphone or any other audio input device to determine that the user provided a particular audio input, such as “more information.”

In some implementations, the content display application can receive a signal indicating that the user requested supplemental information electronically. For example, the user can request more information using a remote control device and selecting the related information presented on the display. More particularly, the user can use a remote control that is configured to issue instructions to a device executing the content display application to request supplemental information related to the information presented at 110.

As another example, the user can request more information from a second screen device associated with the user that is connected to the device executing the content display application (e.g., through a local area network, using Bluetooth, etc.). For example, the user can issue a request for supplemental information to the content display device by transmitting instructions using an application executing on the user's second screen device. Such a request for supplemental information can include inputting a particular gesture (e.g., using a touchscreen) using the second screen device, user selection of a particular user interface element on the second screen device, opening a browser on the second screen device, moving the second screen device in a particular pattern (e.g., where the second screen device is configured with motion sensors), etc.

In some implementations, the content display application can receive a signal indicating that the user requested supplemental information visually. For example, the content display application can receive one or more images and/or videos that can be checked to determine if a user is making a specific gesture and/or pose that indicates that the user would like supplemental information. As another example, the content display application can receive a signal indicating that the user is making a specific gesture and/or pose that indicates that the user would like supplemental information. In a more particular example, the content display application can receive a signal indicating that the user's hand is pointing at a display on which the content is being displayed.

If the content display application detects that the user has interacted with the related information (“YES” at 114), the content display application can move to 116. Otherwise, if it is determined that the user did not interact with the related information (“NO” at 114), the content display application can return to 110 and continue to presented related information.

At 116, the content display application can provide supplemental information to the user based on the user interaction detected at 114 and return to 110. In some implementations, the supplemental information can be provided by presenting the supplemental information on the same display on which the content and the information were presented on. For example, the content display application can provide supplemental information to the user by presenting the information on the display. As another example, the content display application can cause a different application (e.g., a web browser application, etc.) to present the supplemental information to the user.

In some implementations, supplemental information can be any suitable information related to the information presented at 110 and/or the content metadata of the content associated with the information presented at 110. For example, supplemental information can include search results based on the information, search results based on the content metadata, background information (e.g., factual information such as an encyclopedia entry, a news article, etc.) related to the information and/or content metadata, advertisements related to the information and/or content metadata, etc. In another example, supplemental information can include search results based on a topic of the content presented at 106. In a more particular example, if the content presented at 106 is a location, supplemental information can include travel package information (e.g., flight prices, hotel prices, flight and hotel packages, etc.). In another particular example, if the content presented at 106 is related to a sporting event, supplemental information can include scores related to the sporting event, ticket information related to the sporting event (e.g., prices for tickets to upcoming events, etc.). In yet another example, the supplemental information can include a source (e.g., a web page where the content appears, a company that owns the content, an author and/or photographer that produced the content, etc.) of the content.

In some implementations, the supplemental information can be provided to the user by transmitting instructions to a second screen device associated with the user to present the supplemental information. For example, the content display application can transmit instructions to a second screen device (e.g., a smartphone, a tablet, a laptop computer, etc.) associated with the user to open a browser application and display the supplemental information. As another example, if there is an application dedicated to interacting with the content display application on the second screen device associated with the user, the content display application can cause such a dedicated application to launch (if it is not already launched) and present the user with the provided supplemental information.

In some implementations, the content display application can provide the supplemental information to the user by sending an e-mail to an e-mail account associated with the user.

In some implementations, if a user signs in to the content display application using an account that is linked to other services (e.g., an e-mail service, an online storage service, a browser synchronizing service, etc.), the content display application can provide the information through any suitable delivery channels linked with the services associated with the user's account.

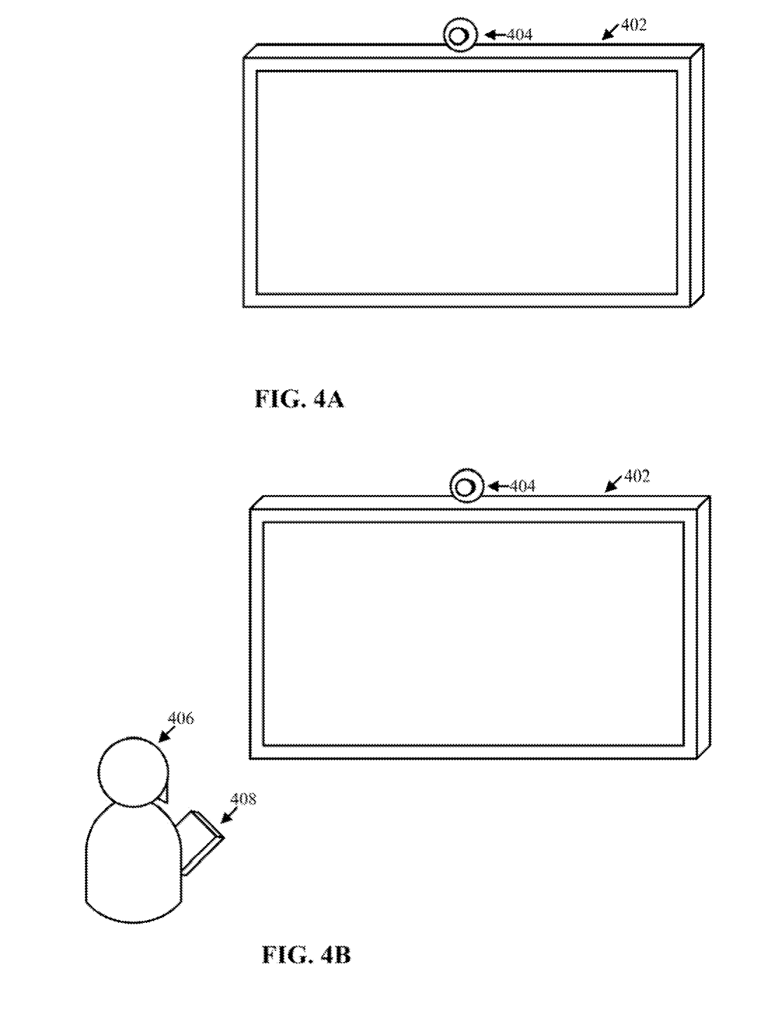

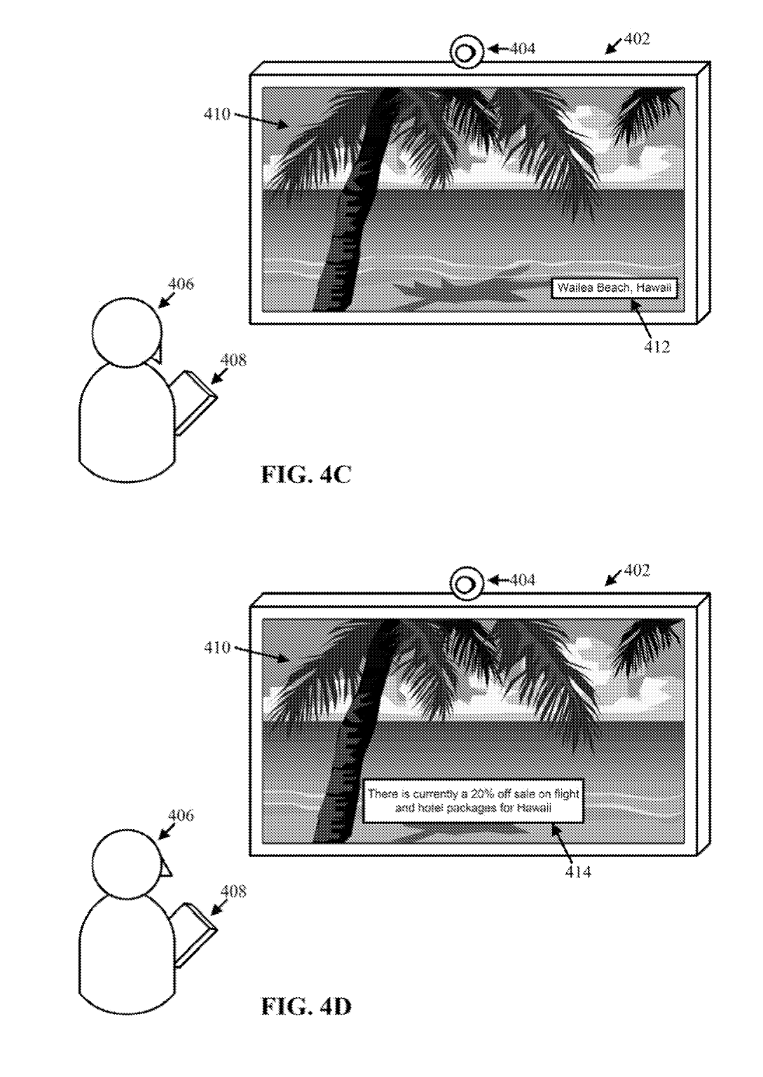

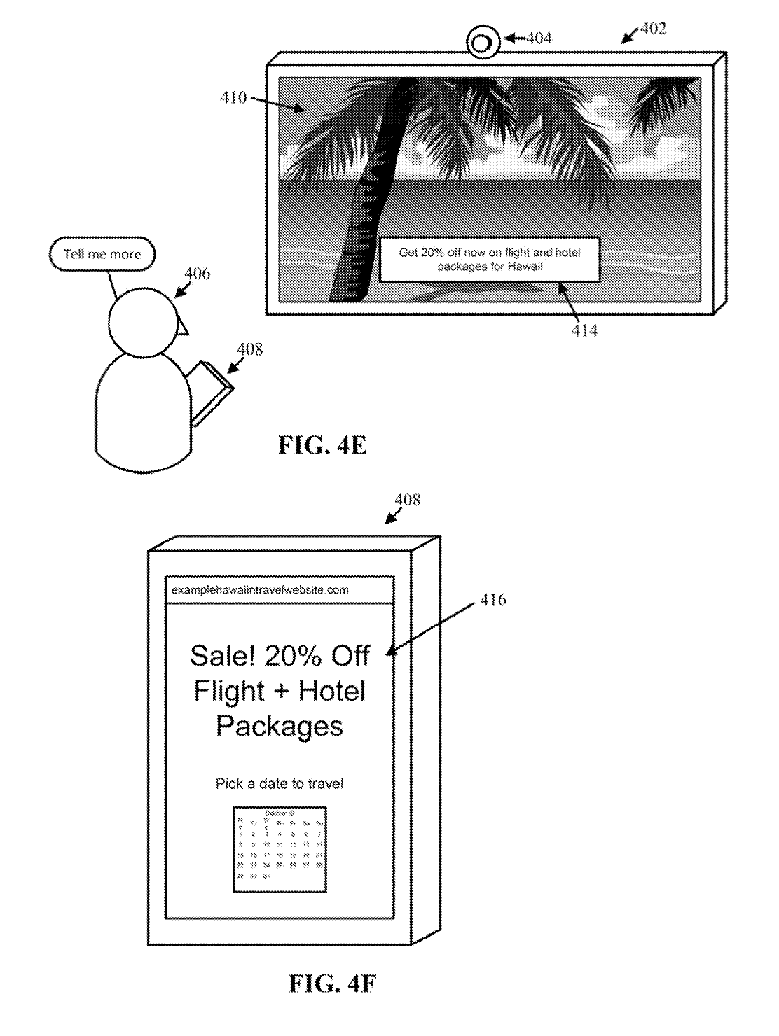

FIGS. 4A to 4F show an illustrative example of supplemental information being provided to a user in response to user attention being detected in accordance with some implementations of the disclosed subject matter. FIG. 4A shows an example of a display device 402 and a camera device 404 in accordance with some implementations. In some implementations, display device 402 can execute the content display application in response to detecting the presence of a user. Additionally, camera device 404 can output images that can be used to determine the presence and/or attention of a user in the field of view of the camera. In some implementations, camera device 404 can be coupled to display device 402. Additionally or alternatively, camera device 404 can be incorporated in display device 402.

In some implementations, as described above in connection with FIG. 1, camera device 404 can periodically capture images so that it can be determined if a user is present in the field of view of camera device 404. Additionally or alternatively, camera device 404 can be triggered by a motion detector (not shown), such as an infrared motion detector, and can capture images when motion is detected in the field of view of camera device 404.

FIG. 4B shows an example where a user 406 has entered the field of view of camera device 404 in accordance with some implementations of the disclosed subject matter. In some implementations, user 406 can be carrying and/or using a second screen device 408 (e.g., a tablet computer, a smartphone, etc.). In this example, the user is using an application running on the second screen device 408 while in front of display device 402. When user 406 enters the field of view of camera device 404, an image can be captured that includes user 406. The image can be processed to determine if a user is present in the field of view of camera device 404. In one example, camera device 404 can perform image processing to the image to detect if a face is present in the image. In such an example, a process for detecting a face in the image can be implemented as hardware, software, firmware, or a combination thereof. In another example, a captured image can be transmitted to a device executing the content display application and the content display application can detect whether a user is present.

In some implementations, the camera and/or the device executing the content display application (e.g., display device 402) can operate in a sleep mode where the amount of power used and a number of features available can be reduced. For example, the camera can capture images at a reduced frame rate (e.g., one frame per second, one frame every five seconds, etc.).

FIG. 4C shows an example of the presentation of content when the presence of user 406 is detected in accordance with some implementations of the disclosed subject matter. In such an example, the content display application can retrieve content and start presenting the content to user 406 on display device 402. In one particular example, popular images (e.g., image 410) of scenic landscapes can be presented to user 406 and a title 412 can be presented on display device 402 that can indicate the location depicted in image 410. In the example shown in FIG. 4C, image 410 shows a beach in Wailea, Hi. In some implementations, title 412 can be determined from associated content metadata received in association with the content being presented to user 406.

FIG. 4C shows an example where user 406 is paying attention to second screen device 408 in accordance with some implementations of the disclosed subject matter. Because the angle between the face of user 406 and display device 402 is greater than the threshold (e.g., because user 406 is looking down at second screen device 408), the content display application does not detect a user action indicative of user attention to the content being presented to the user using display device 402. However, if user 406 turns her face to display device 402 (e.g., because the image of Wailea Beach in Hawaii caught the eye of user 406, or for any other reason), the content display application can detect a user action that indicates user attention to the content being presented. In this case, the content display application can interpret the user turning her head to face the display as indicating that the user is likely looking at the content being presented. It should be noted that the user's actual attention is not interpreted by the content display application, but instead outward actions taken by the user are interpreted to determine the likelihood that the user is paying attention to the content presented to the user.

FIG. 4D shows an example of presentation of information 412 when the content display application detects user attention to image 410 being presented using display device 402 in accordance with some implementations of the disclosed subject matter. In such an example, when user 406 turns her face to look at the image 410, the content display application can cause related information 414 to be presented to the user. As described above, related information, such as related information 414, can be retrieved by the content display application in response to detecting user attention. Additionally or alternatively, the content display application can retrieve related information 414 along with content retrieved for presentation on display device 402 periodically or when content is retrieved and/or updated. In the example of FIG. 4D, related information 414 is showing user information about a sale on flight and hotel packages to Hawaii. In some implementations, related information 414 can be travel related advertising if the user has expressed an interest in travel.

FIG. 4E shows an example of user 406 interacting with related information 414 in accordance with some implementations of the disclosed subject matter. In the example of FIG. 4E, the user verbally interacts with related information 414 by saying, “Tell me more.” The user's voice can be converted to a digital signal using, for example, a microphone (not shown) and any suitable signal processing components. In response to the user interacting with related information 414, the content display application can provide supplemental information corresponding to related information 414 to second screen device 408. For example, the supplemental information can be caused to be transmitted over a network (e.g., a LAN, wireless LAN, the Internet, etc.).

FIG. 4F shows an example of second screen device 408 presenting supplemental information 416 in accordance with some implementations of the disclosed subject matter. In some implementations, if the user interacts with related information 414, the content display application can cause supplemental content 416 to be transmitted to second screen device 408. In one example, the content display application can cause supplemental information 416 to be transmitted to second screen device 408 from a remotely located server. In another example, the content display application can at least temporarily store supplemental information 416 and can then transmit supplement information 416 to second screen device directly (e.g., using Bluetooth, USB, Wireless USB, an ad-hoc wireless network, etc.). In the example of FIG. 4F, user 406 can then further interact with supplemental information 416 by, for example, buying a flight and hotel package.

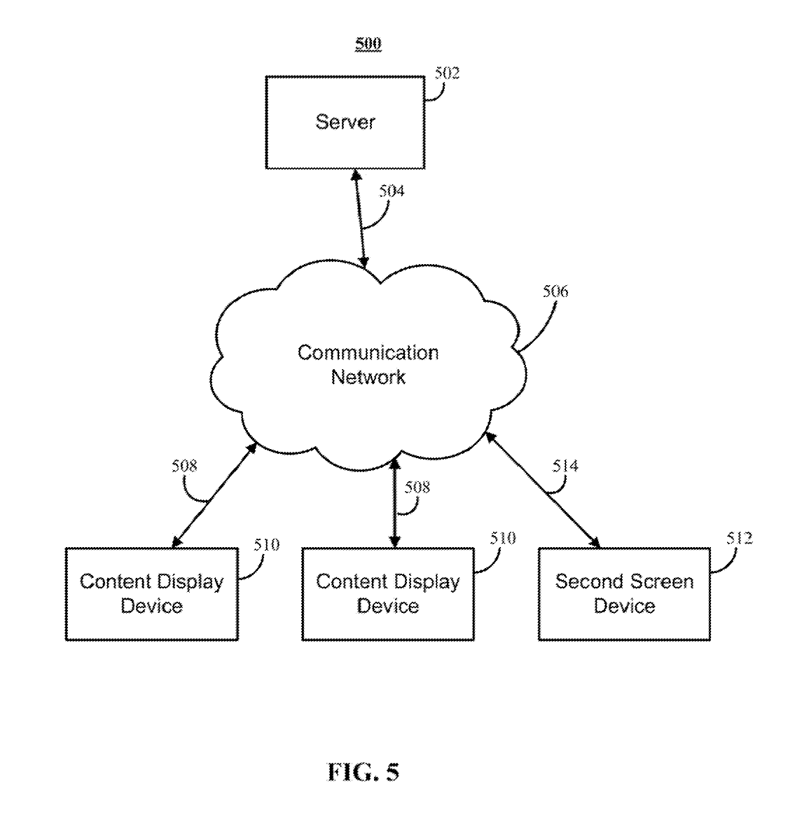

FIG. 5 shows an example 500 of a generalized schematic diagram of a system on which the mechanisms for displaying information related to displayed content upon detection of user attention described herein can be implemented as a content display application in accordance with some implementations of the disclosed subject matter. As illustrated, system 500 can include one or more content display devices 510. Content display devices 510 can be local to each other or remote from each other. Content display devices 510 can be connected by one or more communications links 508 to a communications network 506 that can be linked via a communications link 504 to a server 502. Content display devices 510 can be connected by communication links 508 to communications network 506 to a second screen device 512 via a communication link 514.

System 500 can include one or more servers 502. Server 502 can be any suitable server such as a processor, a computer, a data processing device, or any suitable combination of such devices for: retrieving content, related information and supplemental information; transmitting such content and/or information to content display devices 510 and/or second screen device 512; and any other suitable functions for executing the content display application. For example, the content display application can be distributed into multiple backend components and multiple frontend components or interfaces. In a more particular example, backend components, such as data collection and data distribution can be performed on one or more servers 502.

In some implementations, each of the content display devices 510, second screen device 512 and server 502 can be any of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. For example, content display devices 510 can be implemented as a set-top box, a smart television, a digital-media receiver, a home entertainment system, a personal computer, a laptop computer, a multimedia terminal, a smartphone, a tablet computer, a personal data assistant (PDA), a game console, etc. As another example, second screen device 512 can be implemented as a smartphone, a tablet computer, a personal computer, a laptop computer, a multimedia terminal, a personal data assistant (PDA), etc.

Communications network 506 can be any suitable computer network or combination of such networks including the Internet, an intranet, a wide-area network (WAN), a local-area network (LAN), a wireless network, a digital subscriber line (DSL) network, a frame relay network, an asynchronous transfer mode (ATM) network, a virtual private network (VPN), etc. Communications links 504, 508 and 514 can be any communications links suitable for communicating data among content display devices 510, second screen device 512, and server 502, such as network links, dial-up links, wireless links, hard-wired links, any other suitable communications links, or any suitable combination of such links. Content display devices can enable use of the techniques described herein that can allow the features of the mechanisms to be used. Content display devices 510, second screen device 512 and server 502 can be located at any suitable location.

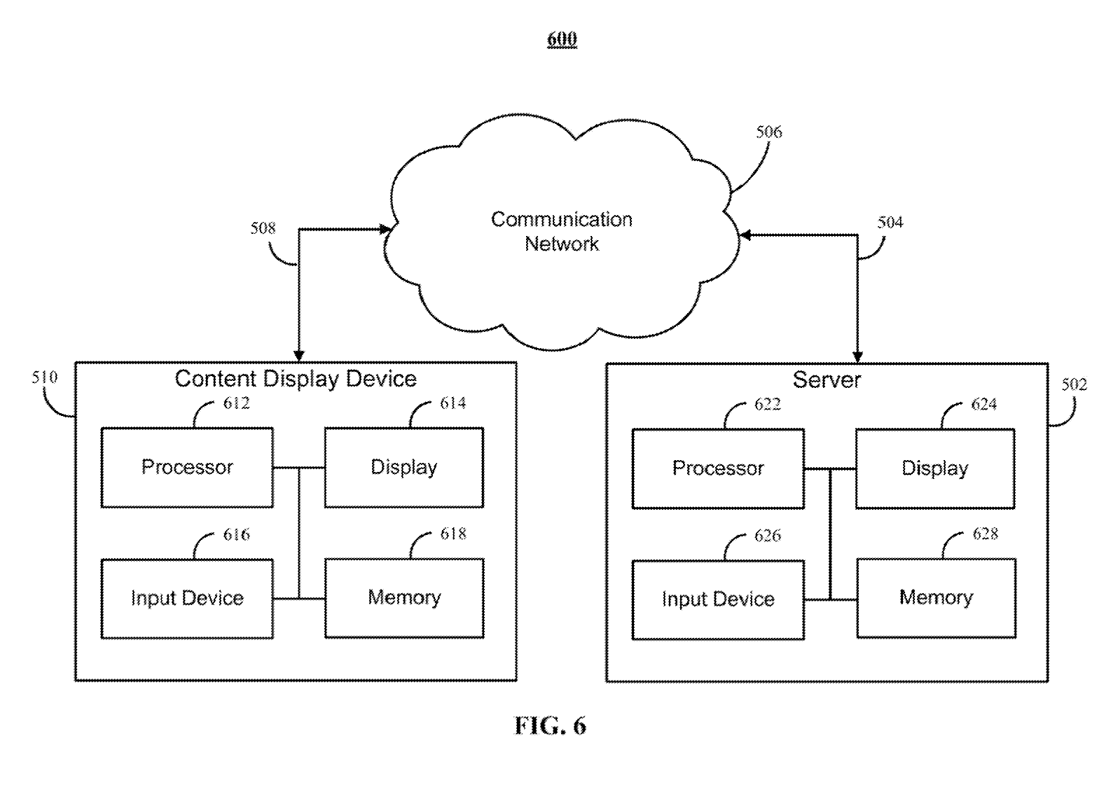

FIG. 6 illustrates an example 600 of hardware that can be used to implement server 502 and one of content display devices 510 depicted in FIG. 5 in accordance with some implementations. Referring to FIG. 6, content display device 510 can include a hardware processor 612, a display 614, an input device 616, and memory 618, which can be interconnected. In some implementations, memory 618 can include a storage device (such as a computer-readable medium) for storing a computer program for controlling hardware processor 612.

Hardware processor 612 can use the computer program to present on display 614 content and/or an interface that allows a user to interact with the mechanisms described herein for displaying information related to displayed content in response to detecting user attention and to send and receive data through communications link 508. Additionally, in some implementations, hardware processor 612 can use the computer program to execute one or more of the processes described herein in connection with FIGS. 1-4, 7-10 and 12. It should also be noted that data received through communications link 508 or any other communications links can be received from any suitable source. In some implementations, hardware processor 612 can send and receive data through communication link 508 or any other communication links using, for example, a transmitter, receiver, transmitter/receiver, transceiver, or any other suitable communication device. Input device 616 can be a camera, a microphone, a remote control, a computer keyboard, a cursor-controller, dial, switchbank, lever, touchscreen, or any other suitable input device.

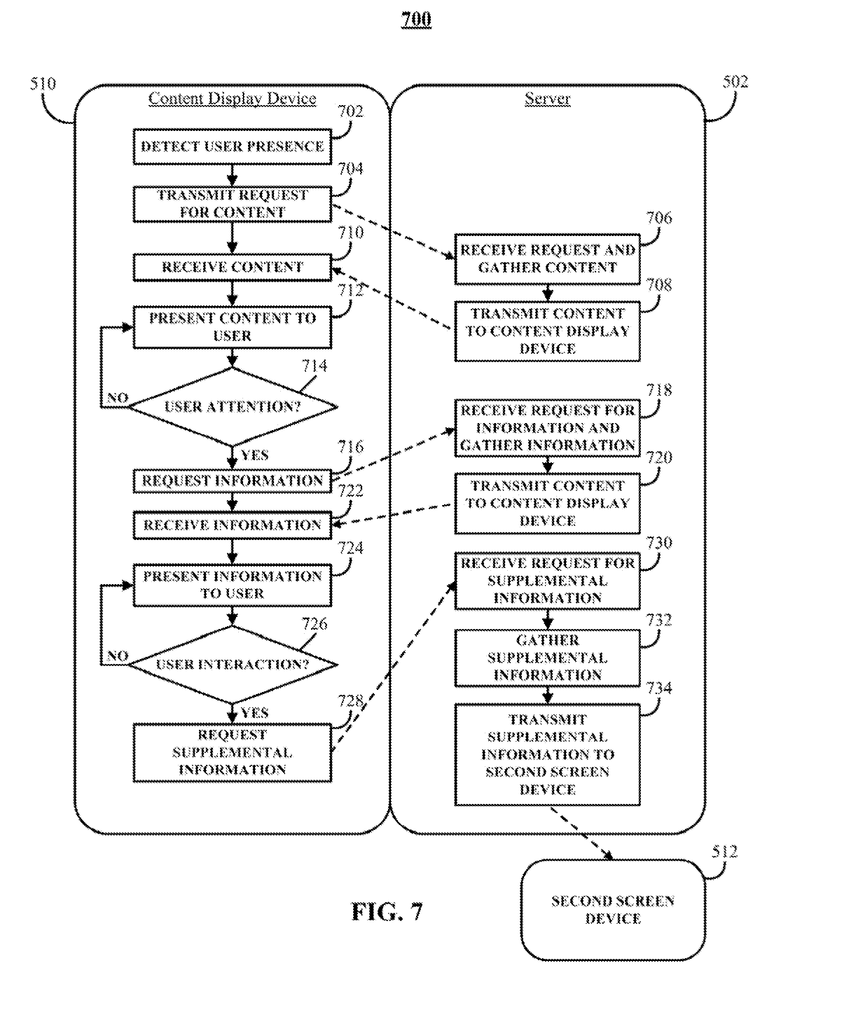

Server 502 can include hardware processor 622, display 624, input device 626, and memory 628, which can be interconnected. In some implementations, memory 628 can include a storage device for storing data received through communications link 504 or through other links, and can also receive commands and values transmitted by one or more users. The storage device can further include a server program for controlling hardware processor 622. In some implementations, hardware processor 622 can use the server program for executing one or more of the processes described herein in connection with FIGS. 7-9, 11 and 12.

The mechanisms described herein for displaying information related to displayed content in response to detection of user attention can be implemented in content display devices 510 as software, firmware, hardware, or any suitable combination thereof.

In some implementations, server 502 can be implemented in one server or can be distributed as any suitable number of servers. For example, multiple servers 502 can be implemented in various locations to increase reliability and/or increase the speed at which the server can communicate with content display devices.

In one particular implementation, the content display application can include client-side software, hardware, or both. For example, the application can encompass a computer program written in a programming language recognizable by the content display device executing the application (e.g., a program written in a programming language, such as, Java, C, Objective-C, C++, C#, Javascript, Visual Basic, ColdFusion, or any other suitable approaches).

In some implementations, content display device 510 executing the content display application can communicate with server 502 to retrieve content and related information from server 502, and to provide supplemental content to a second screen device as shown in example 700 shown in FIG. 7. At 702, content display device 510 can detect a user presence. This can be done using any suitable techniques, such as the techniques described above in connection with FIGS. 1, 2 and 4. For example, the presence of a second screen device 512 on a network can be detected, a motion detector can detect the presence of a user by sensing motion, etc.

At 704, content display device 510 can transmit a request for content to server 502. In some implementations, content display device 510 can request content each time a user presence is detected at 702. Alternatively, content display device 510 can determine if content is stored in memory 618 and can determine when such content was received from server 502. If content display device 510 determines that the content was received more than a predetermined time (e.g., 24 hours, one week, etc.) prior to a current time, content display device 510 can request new and/or updated content at 704. Otherwise, if the content was received less than a predetermined time prior to the current time, content display device 510 can move to 712 without requesting and receiving content.

At 706, server 502 can receive the request for content and can gather content and associated content metadata in response to the request. As described herein, the content can include images, video, advertisements, etc. Additionally or alternatively, the particular content gathered can be based on past user behavior and/or user preferences. At 708, server 502 can transmit the content and associated content metadata gathered at 706 to content display device 510.

Content display device 510 can receive the content and associated content metadata at 710. At 712, the content can be presented to the user by content display device 510 in accordance with implementations described in connection with FIGS. 1 and 4. For example, a slideshow of popular and/or beautiful images can be presented.

At 714, the content display application can determine if the user has performed an action indicative of user attention, such as, turning to face the display. If user attention is detected (“YES” at 714), content display device 510 can request related information at 716 where the related information is related to the content that is presented at 712 when user attention is detected. Otherwise, if user attention is not detected (“NO” at 714), content display device 510 can continue to present content at 712.

At 716, content display device 510 can request the related information from the server 502, and server 502 can receive the request and gather related information at 718, and transmit the related information to content display device 510 at 720. The related information can be received by content display device 510 at 722 and the content display device can present the related information to the user at 724. In some implementations, related information can be received along with content at 710. In such implementations, the actions taken for requesting and receiving related information at 716 to 722 can be omitted.

At 726, the content display application can determine if a user interacts with the related information. If the user does not interact with the related information (“NO” at 726), the content display application can return to 724 and can continue to present related information. Note that the actions of presenting related information and detecting user interaction can be performed so long as the user continues to show attention to the presented content. If the user discontinues showing interest, the content display application can return to 712 and can continue to present the content received at 710.

Otherwise, if the user interacts with the related information (“YES” at 726), the content display device can request supplemental information from server 502 at 728. Server 502 can receive the request for supplemental information at 730, gather the supplemental information at 732, and transmit the supplemental information at 734. In some implementations, the supplemental information can be transmitted to second screen device 512 associated with the user that was detected at 702. The user can then view and/or interact with the supplemental information using second screen device 512.

In some implementations in accordance with the example of FIG. 7, server 502 can be implemented to periodically gather and store content from various sources, related information and supplemental content such that the information is readily available for transmission to content display device 510. In such implementations, the content can be associated with particular related information and/or supplemental content in a database. The content can also be categorized according to interests such that personalized content can be delivered to each user. In some implementations, the content can include user generated content, such as images captured by the user and stored in memory 618, or in a memory (e.g., memory in a personal computer, network attached storage, cloud storage, etc.) connected to content display device 510 through communication network 506.

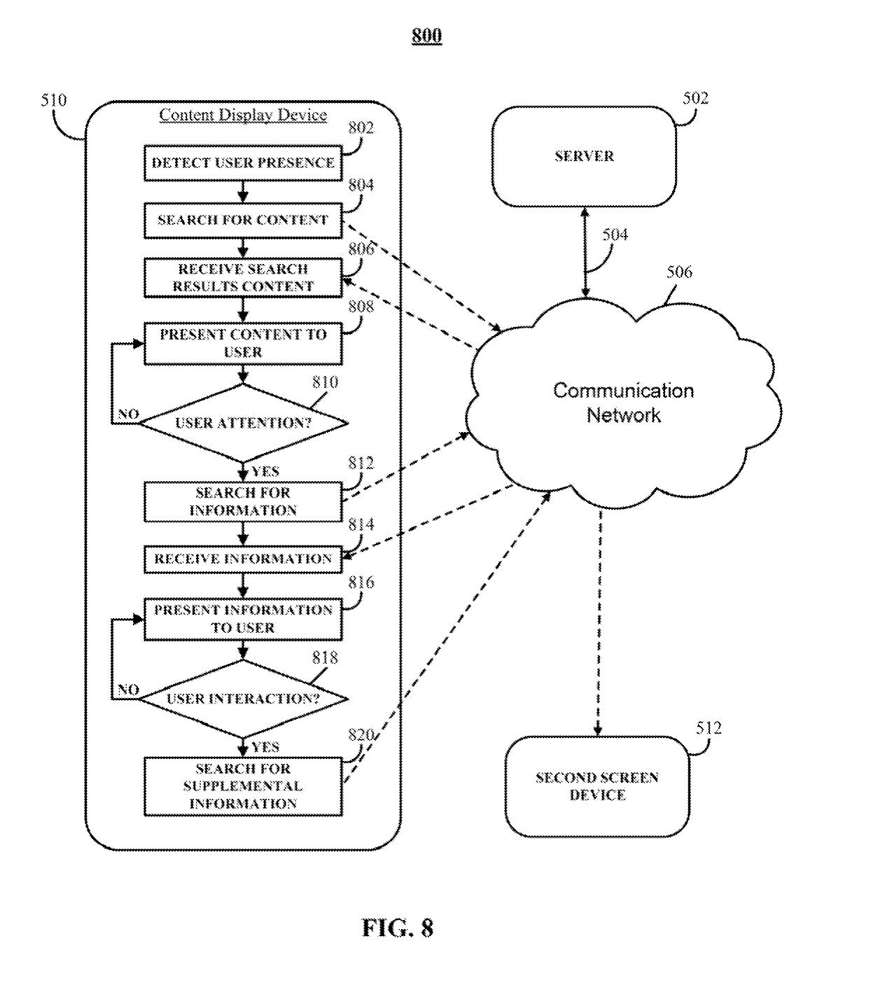

FIG. 8 shows an example 800 that is similar to example 700 but the content is searched for by content display device 510. At 802, content display device 510 can detect a user presence in a similar manner to 702 of the example of FIG. 7. At 804, the content display device can search for content to present to the user. The content display device can search user-generated content (such as images taken by the user) stored in memory 618 of content display device 510, as well as search for sources of content from other sources, such as, content sources accessible on the Internet. For example, the content display device can use a search application programming interface (API) to search various content sources for content that is suitable for the particular user detected at 802.

Content display device 510 can receive content at 806 that was returned as a result of the search performed at 804. Content display device 510 can choose content to store for presentation using any suitable techniques, such as: selecting the most popular search results; selecting the most relevant search results; etc. The resultant content can be downloaded to content display device 510 from server 502 when a search is performed and/or after content display device 510 chooses which content to store.

At 808, content can be presented to the user and user attention can be detected at 810. At 812, if user attention is detected, content display device can perform a search for information related to the content displayed at 808 when user attention was detected at 808. The search for information related to the content can be based on content metadata, user preferences and/or user behavior.

At 814 one or more items of related information can be received and content display device can determine which item to present to the user at 816. This can be determined based on any suitable parameters. If the user interacts with the related information (“YES” at 818), the content display device can search for supplemental information at 820 (e.g., using a search engine) and selected supplemental information can be transmitted to a second screen device 512 associated with the user.

In accordance with various implementations, mechanisms for presenting advertisements related to displayed content upon detection of user attention are provided. In some implementations, the mechanisms for presenting advertisements related to displayed content upon detection of user attention can present content to a user and determine whether the user pays attention to a particular portion of the presented content. For example, the mechanisms for presenting advertisements related to displayed content upon detection of user attention can present a slideshow of images to the user, which can include presenting multiple images simultaneously, and determine based on an eye-gaze direction of the user whether the user is paying attention to a particular image that is being presented. In some implementations, the mechanisms for presenting advertisements related to displayed content upon detection of user attention can request that an advertisement related to the portion of media content to which attention was detected be presented. Additionally, in some implementations, the advertisement can be presented by a second screen device associated with the user. For example, the mechanisms for presenting advertisements related to displayed content upon detection of user attention can request that an advertisement be presented by a mobile phone (e.g., a smartphone) and/or a tablet associated with the user whose attention was detected. Additionally or alternatively, the mechanisms can request that an advertisement be presented by a public and/or shared display visible to the user whose attention was detected. The advertisement can be, for example, related to the image at which the user's gaze was directed in any suitable way. For example, if the image that caught the user's attention is an image of a mountain, an advertisement for hiking equipment can be presented to the user. As another example, the image can be sponsored by a particular advertisement, such that the advertiser has chosen to be associated with the image.

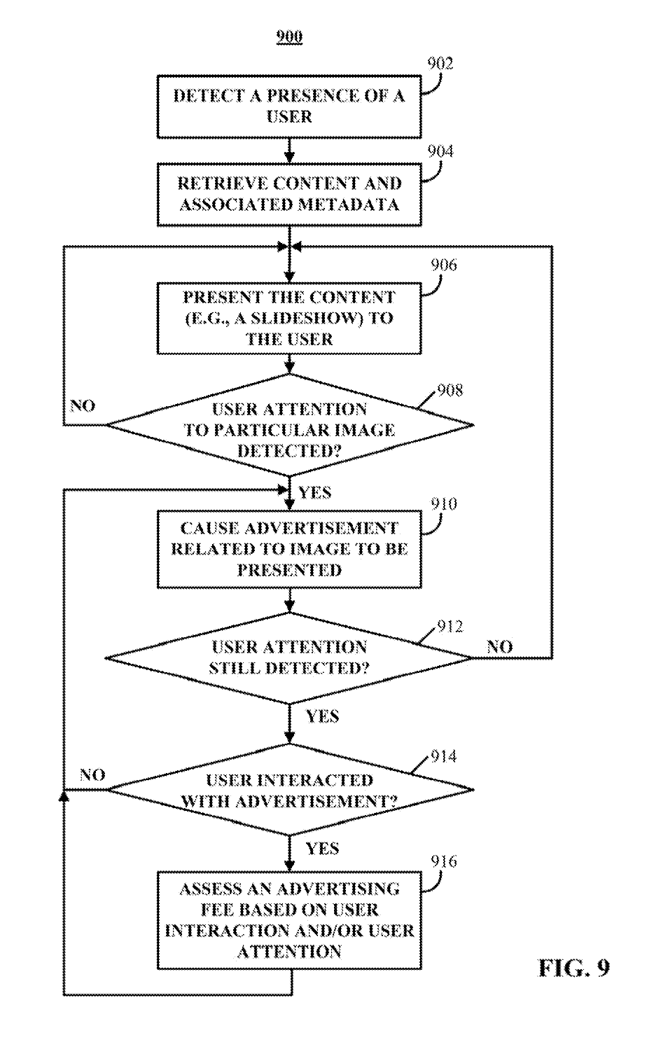

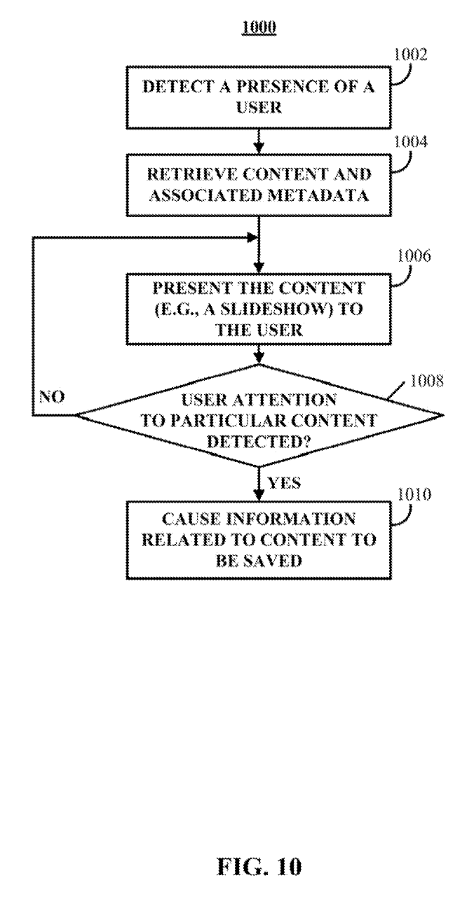

FIG. 9 shows an illustrative example 900 of a process for presenting an advertisement related to displayed content upon detection of user attention to a portion of the content in accordance with some implementations of the disclosed subject matter. As shown in FIG. 9, process 900 can begin at 902 by detecting the presence of a user. Process 900 can use any suitable technique or combination of techniques to detect the presence of the user. For example, process 900 can use one or more techniques as described above in connection with 102 of FIG. 1. As also described above in connection with 102 of FIG. 1, prior to detecting the presence of a user or any other suitable detections described herein, process 900 (and/or any other suitable process) can give the user with an opportunity to provide a consent or authorization to perform such detections.

In some implementations, process 900 can determine the identity of a detected user using any suitable technique or combination of techniques. For example, process 900 can receive image data of the face of one or more users captured by one or more cameras associated with a system executing process 900. Process 900 can then use this image data to identify the users by using one or more facial recognition techniques to match the image data of each user's face to a known user having known facial characteristics. In some implementations, each user identified using one or more facial recognition techniques can be required to consent to process 900 accessing that user's information, such as personal information. This consent can be communicated, for example, using gestures and/or a voice command provided by the user. Additionally or alternatively, this consent can be established based on user persistent user settings establishing consent to be presented with, for example, specific types of advertisements and/or offers.

As another example, process 900 can cause a request to be presented (e.g., using a display and/or one or more speakers associated with a device executing process 900) that each user allow access to that user's identifying information. Such a request can include, for example, a code or other information and instructions to allow access to the user's identifying information. The code can be, for example, alphanumeric, can be encoded into a graphic (e.g., as a QR code), and/or can be presented as an auditory signal (which can be audible and/or inaudible to a human). In some implementations, the request can include a URL or other address where the code can be entered. In a more particular implementation, a user can be instructed to scan a QR code presented by process 900 using a second screen device and a particular application. Scanning the QR code can cause the second screen device (or other suitable device) to navigate to a particular address where the user is prompted to permit process 900 to access the user's identifying information on one or more services (e.g., social networking services).

As yet another example, process 900 can receive identifying information from one or more user devices associated with users whose presence is detected. Process 900 can use any suitable technique or combination of techniques to receive the identifying information. In a more particular example, process 900 can receive the identifying information from a mobile device (e.g., a smartphone, a tablet, a wearable computer, etc.) associated with the user as a response to a request submitted to the mobile device for such identifying information. In some implementations, such a request can initiate a process on the mobile device to supply such information to process 900 as a response to the request. Additionally, in some implementations, the mobile device can query a user prior to sending such a response to request permission from the user to send the response. In another more particular example, process 900 can cause such a response to be sent using any suitable techniques, such as using a short range wireless protocol (e.g., such as the wireless protocol developed by the BLUETOOTH, the WIRELESS USB wireless communication protocol, etc.), over a local area network to which both the mobile device and a device executing process 900 are connected (e.g., by a wireless connection such as a Wi-Fi connection, by a wired connection such as an Ethernet connection, and/or using any other suitable connections). Additionally, in some implementations, process 900 can use any suitable device discovery protocol for determining whether any devices associated with users are present (e.g., in the vicinity of a device executing process 900, on the same network as the device executing process 900, etc.). Such device discovery protocols can include, for example, Simple Service Discovery Protocol (SSDP), discovery protocols associated with the BLUETOOTH wireless protocol, and/or any other suitable device discovery protocols. Any suitable identifying information can be received from the mobile device, such as the user's real name, a URL associated with the user (e.g., a URL of a social networking profile associated with the user), the user's email address, the user's username on a social networking site, the user's phone number, identifying information of the device (e.g., a serial number, a MAC address, and/or any other device identifying information), and/or any other suitable information for identifying the user.

At 904, process 900 can retrieve content and associated metadata. For example, in some implementations, content and associated metadata can be retrieved from local storage of a device executing process 900 (e.g., memory 618 of content display device 510), from a memory of another media device (e.g., that is connected to a network to which the device executing process 900 is connected), from a remote location (e.g., memory 628 of server 502) and/or from any other suitable location such as those described above in connection with 104 of FIG. 1. In some implementations, which content is retrieved (e.g., a type of content, a source of content, subject matter included in the content, etc.) can be based on any suitable criterion or criteria. For example, as described above in connection with FIG. 2, which content is retrieved can be based on whether a known or unknown user is detected at 902, where content related to a known user's interests and/or content associated with a known user can be retrieved. As another example, which content is retrieved can be based on whether one user is detected at 902 or whether multiple users are detected at 902. As yet another example, which content is retrieved can be based on environmental factors in a location of a device executing process 900, such as a time of day, the weather, lighting conditions, any other suitable environmental factor and/or any suitable combination thereof.

At 906, process 900 can cause the content retrieved at 904 to be presented on a display device. Any suitable technique or combination of techniques can be used to present the content. For example, one or more techniques described above in connection with 106 of FIG. 1 can be used in causing the content to be presented on the display device.

At 908, process 900 can determine whether user attention to a particular item of content is detected. As described above, such content can include images, video, and/or any other suitable content. In some implementations, process 900 can receive a signal regarding where on the display a user's gaze is directed and/or whether the user's gaze is directed at the display. In some implementations, a user's eye gaze can be determined using signals from one or more cameras that capture information about the user's eye gaze direction. In some implementations, process 900 can determine that user attention is detected for a particular image when the user's gaze is directed at the image for at least a threshold period of time (e.g., one second, two seconds, etc.) and/or a predetermined proportion of a threshold period of time (e.g., at least seventy-five percent of the previous two seconds). In some implementations, where there is a single image (or other suitable item of content) presented by the display device, process 900 can use other indications of user attention, such as by determining an angle of the user's face with respect to the display, by determining whether the user has performed a particular gesture indicating attention (such as raising an arm), and/or any other suitable indication of user attention such as indications described above in connection with 108 and/or 110 of FIG. 1. In some implementations, process 900 can use process 300 described above in connection with FIG. 3 to determine user attention.

In some implementations, at 908, a content display device (e.g., content display device 510) executing a portion of process 900 (e.g., 902-906), or any other suitable device, can send information related to content that is being presented and an indication of the user attention to that content to a remote server (e.g., server 502) for processing to determine user attention (if any) to content that is being presented. For example, content display device 510 (and/or other suitable device) can send a portion of the content that is being presented (e.g., as a short video clip, a screen shot, and/or any other suitable information) to server 502. As another example, content display device 510 (and/or other suitable device) can send identifying information of the content that is being presented (e.g., including metadata of the content, an address of the content, etc.) to server 502. In some implementations, the portion of content sent to server 502 can indicate a layout of the content on the screen on which it is being presented. Additionally or alternatively, in some implementations, a portion of the screen on which the content is being presented can be included when sending identifying information of the content that is being presented to server 502.

Additionally, in some implementations, content display device 510 (and/or other suitable device) can send gaze information to server 502. Such gaze information can indicate which portion of content that is being presented to which the user's gaze is directed. In some implementations, for each portion of content that is being presented, an indication of whether user attention is directed to the content can be sent as a Boolean flag or operator associated with the content. For example, an indication of whether a user's gaze is directed at a particular portion of content that is being presented can be sent as a flag having a value of “1” to indicate that a user's gaze is directed at the content or “0” to indicate that the user's gaze is not directed at the content.

In some implementations, content display device 510 can send information related to the content being presented and/or gaze information to a remote server (e.g., remote server 502) with a request for an advertisement related to content to which user attention was detected as described below in connection with 910.

If process 900 detects a user action indicative of user attention to a particular image (“YES” at 908), process 900 can move to 910. Otherwise, if process 900 determines that user attention has not been detected (“NO” at 908), process 900 can return to 906 and continue to cause the content to be presented.

At 910, process 900 can cause an advertisement to be presented by a device associated with the user, where the advertisement can be related to the image to which user attention was detected at 908. The advertisement can be related to the image in any suitable way. For example, the advertisement can be selected based on the metadata associated with the image. In a more particular example, if the image is an image of Hawaii (e.g., as described above in connection with FIGS. 4A-4F), metadata of the image can indicate a subject of the image, a location of the image, whether people are included in the image, a source of the image and/or any other suitable information. As another example, one or more advertisements can be pre-selected and associated with the content. In a more particular example, identifying information of the one or more advertisements can be associated with the content as metadata. In another more particular example, identifying information of the content that is included in the metadata can be associated with advertisements (e.g., in a database of advertisements). In yet another more particular example, one or more links to particular advertisements can be associated with the content. As yet another example, any other suitable technique or combination of techniques can be used for selecting the advertisement, such as by holding a real-time auction for the opportunity to choose the advertisement that is selected.

In some implementations, the advertisement can be presented using any suitable technique or combination of techniques by any suitable device associated with the user in any suitable manner. For example, in some implementations, a device executing process 900 can cause the advertisement to be presented by a display connected to the device. Such a display can be associated with the user, for example, based on the display being used to present the content presented at 906.

As another example, in some implementations, a device executing process 900 can cause the advertisement to be presented on a second screen device associated with the user whose attention to the content was detected. In a more particular example, a device executing process 900 can request that an advertisement be sent to the second screen device associated with the user by sending identifying information of the second screen device to a server with instructions to send an advertisement related to the content to the second screen device. The advertisement can then be sent to the second screen device using any suitable techniques. For example, the server can send the advertisement (and/or a link or other instructions that can be used to retrieve the advertisement) to the second screen device by sending a notification that includes the advertisement to the second screen device. As another example, the server can send the advertisement to the second screen device by pushing data to an application being executed by the second screen device. As yet another example, the server can cause a text message or other suitable direct message to be sent to the second screen device.

In some implementations, process 900 can cause the advertisement to be presented by any suitable public and/or shared display that is visible to the user whose attention to the content was detected. In a more particular example, a device executing process 900 can request that an advertisement be sent to a public and/or shared display that is visible to the user. Any suitable technique or combination of techniques can be used to identify available public and/or shared displays and/or to determine whether the public and/or shared display is visible to the user. Such a public and/or shared display can be associated with the user, for example, based on the display being visible to the user.

In some implementations, process 900 can cause the advertisement to be sent to an account associated with the user as a message, such as an email sent to an email account, a message sent to a social media account, and/or any other suitable message sent to any suitable account. Additionally, in some implementations, process 900 can cause the advertisement to be associated with an account of a user, such that when the account is accessed the advertisement is presented to the user. A device used to access such an account associated with the user can be associated with the user, for example, based on its use to access the account.

In some implementations, process 900 can cause an advertisement to be presented to multiple users based on user attention of at least a subset of the multiple users. For example, where attention of multiple users is detected for a particular image (e.g., at 908), the advertisement can be presented to each of the users for whom attention is detected. The advertisement can be presented to the multiple users using any suitable technique or combination of techniques, such as those described above.

At 912, process 900 can determine whether user attention continues to be detected. In some implementations, the same or similar techniques as described above can be used to determine user attention (e.g., face angle, eye-gaze direction, etc.) to determine if the user continues to pay attention. In some implementations, a portion of content to which a user is paying attention can be presented for a prolonged duration. For example, if an image or a video is normally presented for a predetermined period of time, the fact that a user is currently paying attention to the image or video can cause the image or video to be presented for a longer period of time. As another example, if a user is paying attention to an image or video presentation of which is set stop (e.g., by being replaced by another portion of content), the time at which the image or video is set to stop can be delayed.

If process 900 detects that user attention continues to be detected (“YES” at 912), process 900 can move to 914. Otherwise, if process 900 determines that user attention is not still detected (“NO” at 912), process 900 can return to 906 and continue to cause the content to be presented at 906.

At 914, process 900 can determine whether a user interacted with the advertisement that process 900 caused to be presented at 910. For example, process 900 can determine whether the user paid attention to the advertisement using similar techniques as those described herein for determining whether the user is paying attention to a portion of content. As another example, in some implementations, process 900 can receive a signal indicating that the user interacted with the advertisement by requesting additional information related to the advertisement, such as a web site related to the advertisement, an application related to advertisement, a product and/or service advertised by the advertisement, and/or any other suitable additional information. In some implementations, the user can request this additional information electronically by using a remote control device and selecting the related information presented on the display. More particularly, the user can use a remote control that is configured to issue instructions to a device executing process 900 to request supplemental information related to the advertisement presented at 910. As another example, a second screen device can receive a user input from an input device of the second screen device (e.g., a touchscreen, one or more physical or software buttons, a voice recognition circuit or program, etc.), where the input requests the additional information be presented. In some implementations, the second screen device can request that the additional information be presented by a device executing process 900 (e.g., on a television) and/or that the additional information be presented by the second screen device. In some implementations, process 900 can receive a signal indicating that the user interacted with the advertisement by selecting a user interface element to dismiss or delete the advertisement.

Additionally, in some implementations, the second screen device can make such a request regardless of whether the advertisement was presented by a device executing process 900, by the second screen device, and/or by any other suitable device. For example, in cases where the second screen device is used to present the advertisement, input received by the second screen device can cause the second screen device to request the information based on information associated with the advertisement such as a link. As another example, in cases where the device executing process 900 is used to present the advertisement, the second screen device can request additional information related to the advertisement by receiving a link from the device executing process 900. This link can be received using any suitable communication technique or combination of communication techniques such as communication over a local area network to which both the second screen device and the device executing process 900 are connected, communication directly between devices using a peer-to-peer communication system such as Bluetooth, visually communicating the information by the device executing process 900 presenting the information (e.g., encoded in a visual representation that can be decoded by the second screen device such as a QR code, a bar code, etc.) and the second screen device capturing an image of the presented information, and/or using any other suitable communication techniques. In some implementations, information regarding the content that is being presented by a device executing process 900 can be available to and/or shared with a second screen device associated with the user. For example, identifying information and/or metadata of the content which is being presented by process 900 can be communicated to a second screen device over a local connection (e.g., over a local network such as a Wi-Fi network, peer-to-peer using Bluetooth, and/or using any other suitable connection). The second screen device can access this information when a request is made for additional content.

In some implementations, a determination of user attention and/or user interaction with the advertisement at 914 can be made at a device other than the device that cause the advertisement to be presented at 910. For example, the determination at 914 can be made by a second screen device. As another example, the determination at 914 can be made by a combination of devices, such as second screen device and a server from which the advertisement or the additional information related to the advertisement is requested (or an intermediate server that receives the request and redirects or otherwise passes the request to the server that sends the advertisement or additional information).

In some implementations, information about the determination of user attention and/or user interaction with the advertisement at 914 can be made available to an advertiser (and/or other entity associated with the advertiser) associated with the advertisement. The advertiser can use this information to, for example, determine the effectiveness of the advertisement.

If process 900 (or any other suitable process) detects that the user has interacted with the advertisement (“YES” at 914), process 900 can move to 916. Otherwise, if process 900 determines that the user did not interact with the advertisement (“NO” at 914), process 900 can return to 910 and continue to presented related information.

At 916, process 900 can assess a fee to an entity associated with the advertisement that was presented at 910 based on the detected user attention to the advertisement and/or the user interaction with the advertisement. In some implementations, the fee that is assessed by server 502 can be a fee that was agreed upon prior to the advertisement being presented by second screen device 512. For example, an advertiser can cause advertisements to be placed on a pay-per-interaction basis such that the advertiser is only charged a fee when users interact with (or alternatively pay attention to) the advertisement. In some implementations, such a fee can be assessed by a device other than a device which caused the advertisement to be presented at 910. For example, such a fee can be assessed by a server that receives information related to whether interaction with the advertisement has been detected by process 900 (and/or any other suitable process). Any suitable technique or combination of techniques can be used to assess such a fee and the amount of the fee can be based on any suitable factors.

In some implementations, the amount of the fee that is to be assessed can be based on the amount of user interaction and/or user attention to the advertisement detected at 914. For example, for a particular advertisement, an advertiser can specify that they are willing to pay more when a user pays attention to an advertisement for at least a threshold period of time. For example, for a brand awareness advertisement, the advertiser can specify that they would be pay fifty percent more if a user pays attention to the advertisement for at least fifteen seconds. As another example, an advertiser can specify that they are willing to pay more for each additional second that the user pays attention to the advertisement up to a predetermined amount.

FIG. 10 shows an illustrative example 1000 of a process for determining which content presented to a user is interesting to the user in accordance with some implementations of the disclosed subject matter. As shown in FIG. 10, at 1002, process 1000 can detect the presence of a user. Any suitable technique or combination of techniques can be used to detect the presence of a user, such as techniques described above in connection with 102 of FIG. 1, FIG. 2, and/or 902 of FIG. 9.

At 1004, process 1000 can retrieve content and metadata to be presented to a user. Any suitable content having any suitable metadata can be retrieved from any suitable source. For example, the content that is retrieved and/or the sources of content from which the content is retrieved can be those described above in connection with 104 of FIG. 1 and/or 904 of FIG. 9.

At 1006, process 1000 can cause the content retrieved at 1004 to be presented on a display device. As described above in connection with 106 of FIG. 1 and/or 906 of FIG. 9, process 1000 can cause the content to be presented on any suitable display device that is connected to a device executing process 1000 using any suitable connection.

At 1008, process 1000 can detect whether a user has performed an action indicative of user attention to a portion of content that is currently being presented. Any suitable technique or combination of techniques can be used to determine whether the user has performed an action indicative of attention, such as techniques described above in connection with 108 of FIG. 1 and/or 908 of FIG. 9.

At 1010, process 1000 can cause information related to the content to which the user attention was detected to be saved. In some implementations, the information related to the content can include any suitable information. For example, the information related to the content can include identifying information of the content such as an identification number, a title and/or an address of the content. As another example, the information related to the content can include a subject of the content, a resolution at which the content was presented, a location on the display at which the content was presented, information identifying other content that was presented concurrently with the content, when the content was presented, how long user attention to the content was detected, environmental data such as the weather, and/or any other suitable information related to the content and/or the circumstances in which the content was presented.

In some implementations, the information related to the content can be saved using any suitable technique or combination of techniques. For example, the information can be saved locally in a memory of a device executing process 1000 (e.g., memory 618 of content display device 510 executing process 1000). As another example, the information can be saved remotely. As a more particular example, the information can be saved remotely on a server associated with the delivery and/or presentation of the content retrieved at 1004 for use in determining which content is most interesting to the user and/or other users. In another more particular example, the information can be saved remotely on a server associated with the user whose attention was detected for use in determining the user's interests, for determining what types of content the user objectively finds most interesting (e.g., as indicated by attention), for determining a mood of the user, and/or for any other suitable purpose.

In some implementations, the information related to the content can be associated with the user whose attention to the content was detected. For example, the information related to the content can be saved in association with identifying information of the user and/or with an account associated with the user. In such an example, the information can be used to personalize which content it presented to the user.

In some implementations, the saved information related to the content can be aggregated to determine which content is most effective at attracting user attention, whether presenting content in a particular order is more likely to attract a user's attention, whether certain content is more effective at attracting user attention at a certain time of day, whether certain content is more effective at attracting user attention based on the weather at the location where the content is presented, whether certain content is more effective at attracting user attention during a particular season at the location at which the content is being presented, etc.

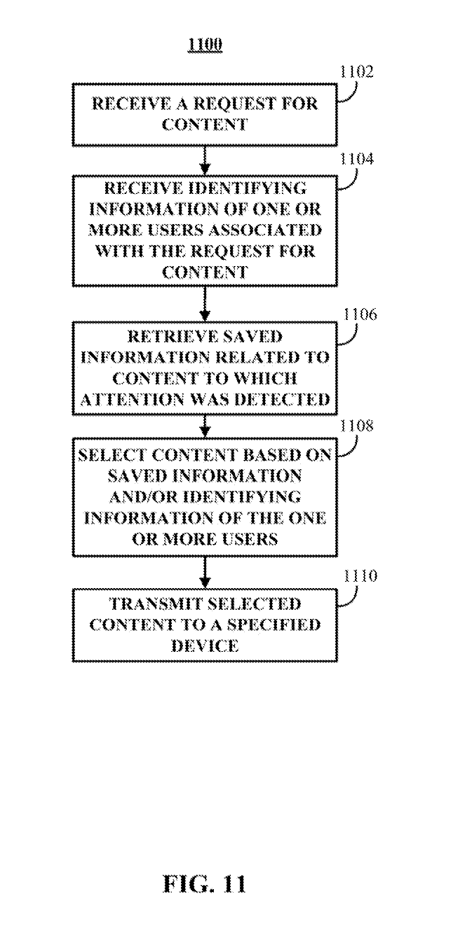

FIG. 11 shows an illustrative example 1100 of a process for presenting content based on which content caused users to pay attention in accordance with some implementations of the disclosed subject matter. As shown in FIG. 11, at 1102, process 1100 can receive a request for content. In some implementations such a request can be received from one or more of the processes described in connection with FIGS. 1, 9 and 10 and/or from a device executing one or more of the processes described in connection with FIGS. 1, 9 and 10. In some implementations, process 1100 can be executed by a device executing one of the processes described in connection with FIGS. 1, 9 and 10, for example, when content is stored locally. Additionally or alternatively, in some implementations, process 1100 can be executed by a device that is remote from a device executing one or more of the processes described in connection with FIGS. 1, 9 and 10, such as by a server that suggests content to be presented by a device executing one or more of the processes described in connection with FIGS. 1, 9 and 10. In some implementations, the requested content can be an advertisement.

In some implementations, the request for content can include parameters of the request, such as a type of content that is requested, an amount of content that is requested, information related to a size and/or resolution of a display to be used in presenting the content, etc.

At 1104, process 1100 can receive identifying information of one or more users associated with the request for content. Any suitable identifying information can be received, such as the user's real name, a URL associated with the user (e.g., a URL of a social networking profile associated with the user), the user's email address, the user's username on a social networking site, the user's phone number, identifying information of a device associated with the user (e.g., a serial number, a MAC address, and/or any other device identifying information), and/or any other suitable information for identifying the user. In some implementations, such identifying information can include any suitable information for determining which content to transmit in response to the request. For example, the identifying information can be used to identify which content the one or more users found to be of interest in the past. In some implementations, identifying information can be treated such that personal information of the user is obscured. For example, the identifying information can be an assigned identification number or code name and information about which content the user paid attention to can be associated with such an identification number or code name.

In some implementations, the identifying information of the one or more users can be used to retrieve the preferences of the one or more users. These preferences can be used, for example, to identify one or more topics of content in which the user has shown interest.

At 1106, process 1100 can retrieve saved information related to content to which attention was detected (e.g., as described above in connection with 1008 of FIG. 10). This saved information can be information that was saved based on the attention of a user corresponding to user identifying information received at 1104, users that has shown interest in similar content as one of the users corresponding to the identifying information received at 1104, all users, and/or any other suitable users.

At 1108, process 1100 can select content based on the saved information and/or the identifying information of the one or more users. For example, in some implementations, process 1100 can select content based on a score for the content that is calculated based on the saved information. In a more particular example, when user attention is detected for a particular portion of content and information related to that detection is saved (e.g., as described above in connection with 1010) the saved information can be used in calculating a score for that portion of content. The score that is calculated can be a measure of how interesting the content is based on the attention of users to the content. In some implementations, such a score can also include information related to characteristics of the users that paid attention to the portion of content. When content is requested for a particular user, process 1100 can select content for the user based on the scores. The scores can be modified based on a similarity between the user requesting the content (e.g., based on known information about the user, such as information associated with the identifying information of the user) and the users that paid attention to the scored content. In some implementations, the user can be clustered with other users that have similar interests (e.g., using cluster analysis techniques and/or any other suitable machine learning techniques, by categorizing a user based on the user's interests, by a self-classification of the user, based on one or more topics identified by the user as a topic of interest, and/or using any other suitable techniques).

In some implementations, process 1100 can select content based on one or more topics of interest to the user or users whose identifying information was received at 1104. These topics of interest can be determined, for example, based on saved information related to portions of content to which the user or users paid attention, and/or using any other suitable technique or combination of techniques.

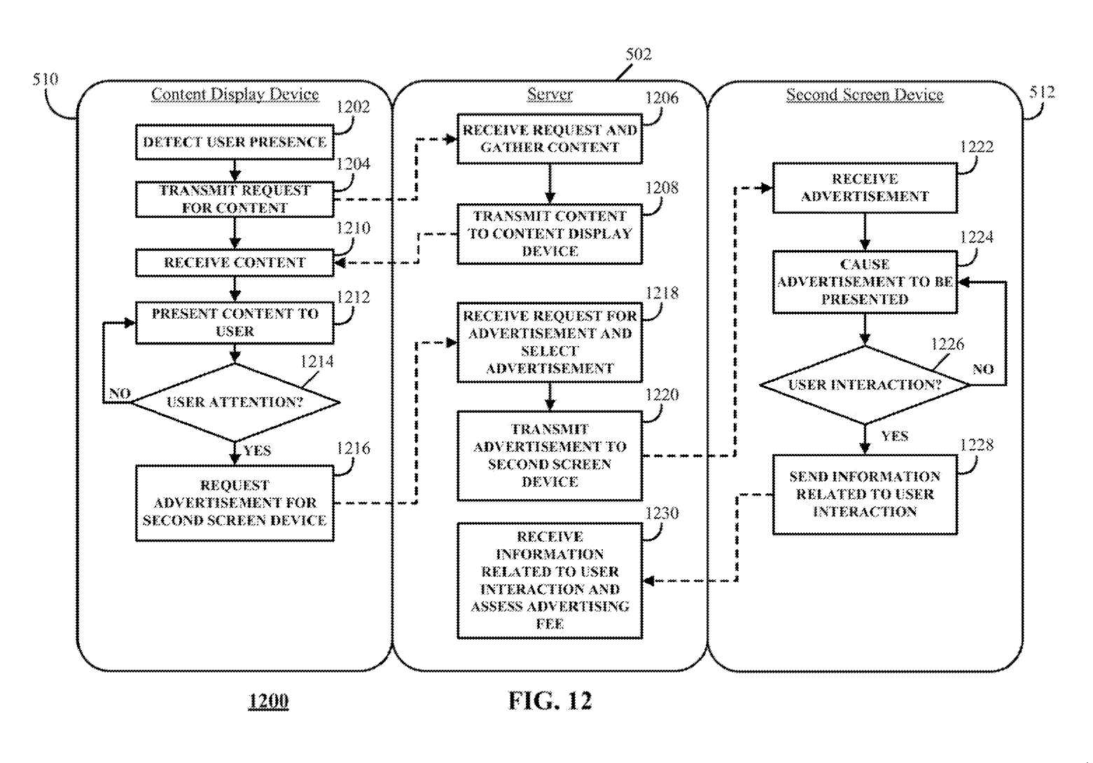

In some implementations, content display device 510 executing at least a portion of one or more of the processes in FIGS. 9 and 10 can communicate with server 502 to retrieve content and related information from server 502, and to provide an advertisement to second screen device 512 as shown in example 1200 shown in FIG. 12. At 1202, content display device 510 can detect a user presence. Content display device 510 can detect the user presence using any suitable techniques, such as the techniques described above in connection with FIGS. 1, 2, 4, 9 and 10.

At 1204, content display device 510 can cause a request for content to be transmitted to server 502. In some implementations, content display device 510 can request content each time a user presence is detected at 1202. Alternatively, content display device 510 can determine if content is stored in memory 618 and can determine when such content was received from server 502. If content display device 510 determines that the content was received more than a predetermined time (e.g., 24 hours, one week, etc.) prior to a current time, content display device 510 can request new and/or updated content at 1204. Otherwise, if the content was received less than a predetermined time prior to the current time, content display device 510 can move to 1212 without requesting and receiving content. In some implementations, the request for content at 1204 can include user identifying information that can be used by server 502 to determine the preferences of the user and/or can be used for finding content the user will likely find interesting based on what the user and/or other similar users have found interesting. Additionally or alternatively, in some implementations, the request for content at 1204 can include any other suitable information related to what type or types of content are requested and/or one or more topics or subjects of content that are requested.

At 1206, server 502 can receive the request for content and gather content to be presented to the user detected at 1202. Server 502 can use any suitable technique or combination of techniques to gather content to be presented. As described herein, the content can include images, video, advertisements, etc. Additionally or alternatively, the particular content gathered can be based on past user behavior and/or user preferences. In some implementations, gathering the content can include determining a location from which the content can be retrieved (which can, for example, be another server) and sending the address to content display device 510, which can then retrieve and present the content.

At 1208, server 502 can transmit the content to content display device 510 that requested the content. Additionally or alternatively, as described above, server 502 can transmit instructions for retrieving the content to content display device 510.

At 1210, content display device 510 can receive the content (and/or instructions for retrieving content) transmitted by server 502. At 1212, content display device 510 can cause the content to be presented to the user (or users) whose presence was detected at 1202. Content display device 510 can use any suitable technique to present the content, such as techniques described above in connection with FIGS. 1, 4, 9 and 10. In a more particular example, content display device 510 can cause a slideshow of images to be presented.

At 1214, content display device 510 can determine if the user has performed an action indicative of user attention, such as, facing the display and looking at a particular portion of the content that is being presented. As described above in connection with FIGS. 1, 4 and 9, an eye-gaze of the user can be used to determine a portion of the content that the user is looking at (and/or if the user is looking at any of the content that is being presented).

If user attention is detected (“YES” at 1214), content display device 510 can request that an advertisement be presented on a second screen device associated with a user whose attention was detected, at 1216. Otherwise, if user attention is not detected (“No” at 1214), content display device can continue to detect user attention at 1214. In some implementations, any suitable information can be included in the request that an advertisement be presented on the second screen device, such as information discussed in connection with 910 of FIG. 9. For example, identifying information of the user and/or second screen device 512 associated with the user can be sent with the request. As another example, identifying information and/or metadata of the content to which user attention was detected can be sent with the request.

At 1218, server 502 can receive the request for an advertisement and select an advertisement for presentation to the user. As described above in connection with 910 of FIG. 9, any suitable technique or combination of techniques can be used to select an advertisement.

At 1220, server 502 can cause the advertisement to be presented on second screen device 512 associated with the user. Any suitable technique or combination of techniques can be used to cause the advertisement to be presented, such as techniques described above in connection with 910 of FIG. 9.

At 1222, second screen device 512 can receive the advertisement. As described above in connection with FIG. 9, second screen device 512 can receive the advertisement using any suitable technique or combination of techniques.

At 1224, second screen device 512 can cause the advertisement to be presented to the user and can determine, at 1226, whether the user has interacted with the advertisement. In some implementations, interaction with an advertisement can include any suitable interaction such as those described above in connection with 914.

At 1228, second screen device 512 can cause information related to user interaction with the advertisement to be sent to server 502. Any suitable information related to the user interaction can be sent to server 502, such as an indication that the user positively interacted with the advertisement (e.g., by requesting more information from the advertisement, initiating a purchase of a product and/or service associated with the advertisement, and/or any other positive interaction), an indication that the user negatively interacted with the advertisement (e.g., by dismissing the advertisement, by deleting the advertisement, by requesting that similar advertisements be blocked in the future, and/or any other negative interaction), and/or any other suitable indication that the user interacted with the advertisement.

At 1230, server 502 can receive information related to user interaction and cause a fee to be assessed to an entity associated with the advertisement based on the interaction. In some implementations, the fee that is assessed by server 502 can be a fee that was agreed upon prior to the advertisement being presented by second screen device 512. Any suitable terms for assessing the fee can be used in determining the amount of the fee, such as the terms described above in connection with 916 of FIG. 9.

It should be noted that in implementations described herein in which the mechanisms for presenting advertisements related to displayed content upon detection of user attention (or other mechanisms described herein) collect information about a particular user, the user will be provided with an opportunity to control whether the mechanisms collect information about particular users and/or how collected user information is used by the mechanisms described herein. Examples of information about a user can include an image of the user, the user's interests, the user's location, etc. Additionally, certain information about the user can be stored locally (e.g., not shared), encrypted, and/or treated in one or more ways before it is stored to remove personal information. For example, a user's identity can be treated such that no personal information can be determined for the user. As another example, a user's geographic location can be generalized where location information is obtained (e.g., to a city level, a ZIP code level, a state level, etc.), so that a particular location of a user cannot be determined. Using these techniques and others described herein, the user can have control over what information is collected about the user and/or how that information is used by the topic determination application (or other mechanisms). As yet another example, user interest data determined based on which content the user paid attention to can be generalized such that the particular images and/or particular content in the images to which user attention was detected is not stored. In a more particular example, if user attention is detected to an image including a particular brand of bicycle that was captured at a particular location that includes mountain scenery, information that the user paid attention to an image with a bicycle and/or mountains can be stored without indicating which brand of bicycle is in the image or the actual location at which the image was captured.

In some implementations, any suitable computer readable media can be used for storing instructions for performing the functions and/or processes described herein. For example, in some implementations, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be understood that the above described steps of the processes of FIGS. 1-4 and 7-12 can be executed or performed in any order or sequence not limited to the order and sequence shown and described in the figures. Also, some of the above steps of the processes of FIGS. 1-4 and 7-12 can be executed or performed substantially simultaneously where appropriate or in parallel to reduce latency and processing times.

It should also be noted that, as used herein, the term mechanism can encompass hardware, software, firmware, or any suitable combination thereof.

Accordingly, methods, systems, and media for presenting advertisements related to displayed content upon detection of user attention are provided.

Although the invention has been described and illustrated in the foregoing illustrative implementations, it is understood that the present disclosure has been made only by way of example, and that numerous changes in the details of implementation of the invention can be made without departing from the spirit and scope of the invention, which is limited only by the claims that follow. Features of the disclosed implementations can be combined and rearranged in various ways.

What is claimed is:

1. A method for presenting information to a user, the method comprising:
detecting, using a hardware processor, presence of a user;
causing content to be presented in response to detecting the presence of the user;
detecting an eye-gaze direction of the user;
detecting user attention to at least a portion of the content presented based on the eye-gaze direction of the user; and
causing an advertisement related to the portion of the content to which user attention is detected to be presented by a device associated with the user.

2. The method of claim 1, further comprising:
causing metadata associated with the portion of the content to which user attention is detected to be associated with the user; and
causing additional content to be presented to the user based at least in part on the metadata that has been associated with the user.

3. The method of claim 1, wherein detecting the presence of the user comprises detecting that a mobile device associated with the user is connected to a local area network, and wherein causing the advertisement related to the portion of the content to which user attention is detected comprises causing the advertisement to be presented by the mobile device.

4. The method of claim 3, further comprising:
identifying the user; and
determining that the user is associated with the mobile device based on the identification.

5. The method of claim 4, wherein identifying the user further comprises receiving image data of a person's face and comparing the image data with a known image of the user to determine the identity of the user.

6. The method of claim 1, further comprising:
detecting the presence of a plurality of mobile devices including the mobile device associated with the user;
identifying a plurality of users;
determining that a subset of the plurality of users are each associated with one of the plurality of mobile devices;
detecting an eye-gaze direction of each of the subset of the plurality of users;
detecting user attention of a first user of the subset of the plurality of users to at least a portion of the content presented to the plurality of users based on the eye-gaze direction of the first user; and
causing an advertisement related to the portion of the content to which user attention of the first user is detected to be presented by a first mobile device associated with the first user.

7. The method of claim 6, further comprising:
requesting content based on the identification of the subset of the plurality of users;
receiving content to be presented in response to the request; and
wherein causing content to be presented comprises causing the received content to be presented.

8. A system for presenting information to a user, the system comprising:
a hardware processor that is programmed to:
detect presence of a user;
cause content to be presented in response to detecting the presence of the user;
detect an eye-gaze direction of the user;
detect user attention to at least a portion of the content presented based on the eye-gaze direction of the user; and
cause an advertisement related to the portion of the content to which user attention is detected to be presented by a device associated with the user.

9. The system of claim 8, wherein the hardware processor is further programmed to:
cause metadata associated with the portion of the content to which user attention is detected to be associated with the user; and
cause additional content to be presented to the user based at least in part on the metadata that has been associated with the user.

10. The system of claim 8, wherein the hardware processor is further programmed to:
detect that a mobile device associated with the user is connected to a local area network; and
cause the advertisement to be presented by the mobile device.

11. The system of claim 10, wherein the hardware processor is further programmed to:
identify the user; and
determine that the user is associated with the mobile device based on the identification.

12. The system of claim 11, wherein the hardware processor is further programmed to receive image data of a person's face and compare the image data with a known image of the user to determine the identity of the user.

13. The system of claim 8, wherein the hardware processor is further programmed to:
detect the presence of a plurality of mobile devices including the mobile device associated with the user;
identify a plurality of users;
determine that a subset of the plurality of users are each associated with one of the plurality of mobile devices;
detect an eye-gaze direction of each of the subset of the plurality of users;
detect user attention of a first user of the subset of the plurality of users to at least a portion of the content presented to the plurality of users based on the eye-gaze direction of the first user; and
cause an advertisement related to the portion of the content to which user attention of the first user is detected to be presented by a first mobile device associated with the first user.

14. The system of claim 13, wherein the hardware processor is further programmed to:
request content based on the identification of the subset of the plurality of users;
receive content to be presented in response to the request; and
wherein causing content to be presented comprises causing the received content to be presented.

15. A non-transitory computer-readable medium containing computer executable instructions that, when executed by a processor, cause the processor to perform a method for presenting information to a user, the method comprising:
detecting presence of a user;
causing content to be presented in response to detecting the presence of the user;
detecting an eye-gaze direction of the user;
detecting user attention to at least a portion of the content presented based on the eye-gaze direction of the user; and
causing an advertisement related to the portion of the content to which user attention is detected to be presented by a device associated with the user.

16. The non-transitory computer-readable medium of claim 15, wherein the method further comprises:
causing metadata associated with the portion of the content to which user attention is detected to be associated with the user; and
causing additional content to be presented to the user based at least in part on the metadata that has been associated with the user.

17. The non-transitory computer-readable medium of claim 15, wherein detecting the presence of the user comprises detecting that a mobile device associated with the user is connected to a local area network, and wherein causing the advertisement related to the portion of the content to which user attention is detected comprises causing the advertisement to be presented by the mobile device.

18. The non-transitory computer-readable medium of claim 17, wherein the method further comprises:
identifying the user; and
determining that the user is associated with the mobile device based on the identification.

19. The non-transitory computer-readable medium of claim 18, wherein identifying the user further comprises receiving image data of a person's face and comparing the image data with a known image of the user to determine the identity of the user.

20. The non-transitory computer-readable medium of claim 15, wherein the method further comprises:
detecting the presence of a plurality of mobile devices including the mobile device associated with the user;
identifying a plurality of users;
determining that a subset of the plurality of users are each associated with one of the plurality of mobile devices;
detecting an eye-gaze direction of each of the subset of the plurality of users;
detecting user attention of a first user of the subset of the plurality of users to at least a portion of the content presented to the plurality of users based on the eye-gaze direction of the first user; and
causing an advertisement related to the portion of the content to which user attention of the first user is detected to be presented by a first mobile device associated with the first user.

21. The non-transitory computer-readable medium of claim 20, wherein the method further comprises:
requesting content based on the identification of the subset of the plurality of users;
receiving content to be presented in response to the request; and
wherein causing content to be presented comprises causing the received content to be presented.
